(19) United States
(12) Patent Application Publication
(10) Pub. No.: US 2026/0057413 A1
(43) Pub. Date: Feb. 26, 2026

(54) SYSTEM AND METHOD FOR RECOMMENDING ACTIONS ON A DEVICE

(71) Applicant: Voicemonk, Inc., Sunnyvale, CA (US)

(72) Inventors: Jagadeshwar Nomula, Sunnyvale, CA (US); Vinesh Gudla, Pleasanton, CA (US); Durga Prasad Velamuri, Fremont, CA (US); Vineel Yalamarthy, Rajahmundry (IN)

(73) Assignee: Voicemonk, Inc., Sunnyvale, CA (US)

(21) Appl. No.: 19/377,016

(22) Filed: Nov. 2, 2025

Related U.S. Application Data
(63) Continuation-in-part of application No. 19/234,241, filed on Jun. 10, 2025.
(63) Continuation-in-part of application No. 18/474,130, filed on Sep. 25, 2023.
Application No. 19/234,241 is a continuation of application No. 16/006,850, filed on Jun. 13, 2018, now Pat. No. 12,450,631.
Application No. 16/006,850 is a continuation-in-part of application No. 13/089,772, filed on Apr. 19, 2011, now abandoned.
Application No. 13/089,772 is a continuation-in-part of application No. 15/245,208, filed on Aug. 24, 2016.
Application No. 15/245,208 is a continuation-in-part of application No. 13/208,338, filed on Aug. 12, 2011, now abandoned.
Application No. 13/208,338 is a continuation-in-part of application No. 15/391,837, filed on Dec. 27, 2016, now abandoned.
Application No. 15/391,837 is a continuation-in-part of application No. 15/356,512, filed on Nov. 18, 2016, now Pat. No. 11,068,954.
Application No. 18/474,130 is a continuation of application No. 17/484,779, filed on Sep. 24, 2021, now Pat. No. 11,769,175.
Application No. 17/484,779 is a continuation of application No. 15/441,239, filed on Feb. 24, 2017, now Pat. No. 11,144,964.
Application No. 15/441,239 is a continuation-in-part of application No. 15/391,837, filed on Dec. 27, 2016, now abandoned.
Application No. 15/391,837 is a continuation-in-part of application No. 15/356,512, filed on Nov. 18, 2016, now Pat. No. 11,068,954.
(63) Continuation-in-part of application No. 16/245,188, filed on Jan. 10, 2019.
(60) Provisional application No. 61/400,663, filed on Aug. 2, 2010.
(60) Provisional application No. 62/257,722, filed on Nov. 20, 2015.
(60) Provisional application No. 62/275,043, filed on Jan. 5, 2016.
(60) Provisional application No. 62/318,762, filed on Apr. 5, 2016.
(60) Provisional application No. 62/543,400, filed on Aug. 10, 2017.
(60) Provisional application No. 62/616,428, filed on Jan. 12, 2018.

(51) Int. Cl. G06Q 30/0251; G06Q 30/0241; G06Q 50/00; H04L 67/306; H04L 67/50; H04W 4/21; H04W 4/23

(52) U.S. Cl. CPC G06Q 30/0269; G06Q 30/0255; G06Q 30/0277; G06Q 50/01; H04L 67/306; H04L 67/535; H04W 4/21; H04W 4/23

(57) ABSTRACT

A computer-implemented method for usage recall on a user device is disclosed. The method includes capturing, at intervals, visual content presented on a display of the user device; analyzing the captured visual content by dividing the content into pixels and processing the pixels with a neural network trained to recognize visual elements and their positions to produce an element map; storing, in a local context store, entries associating the captured content with a time, an application or window identifier, and descriptors of the recognized elements; receiving a natural-language user query describing a past activity; retrieving, from the local context store, an entry responsive to the user query; and re-establishing at least part of a prior application state by generating user-interface events directed to a target visual element from the element map. The neural network may comprise deep or recurrent layers with LSTM and attention mechanisms optimized by reinforcement learning.

### CROSS-REFERENCE TO RELATED APPLICATION

This application is a continuation-in-part of U.S. application Ser. No. 16/245,188, filed Jan. 10, 2019, which claims priority from U.S. Provisional Patent Application No. 62/616,428, filed Jan. 12, 2018. Further, the present application is also a continuation-in-part of U.S. application Ser. No. 19/234,241, filed Jun. 10, 2025, which is a continuation of U.S. application Ser. No. 16/006,850, filed Jun. 13, 2018, which claims the benefit of U.S. Provisional Patent Application No. 62/543,400, filed Aug. 10, 2017. The U.S. application Ser. No. 16/006,850 is a continuation-in-part of U.S. application Ser. Nos. 13/089,772, filed Apr. 19, 2011; Ser. No. 13/208,338, filed Aug. 12, 2011; Ser. No. 15/245,208, filed Aug. 24, 2016; Ser. No. 15/356,512, filed Nov. 18, 2016; and Ser. No. 15/391,837, filed Dec. 27, 2016. The U.S. application Ser. No. 15/245,208 claims the benefit of U.S. Provisional Patent Application No. 61/400,663, filed Aug. 2, 2010. The U.S. application Ser. No. 15/356,512 claims the benefit of U.S. Provisional Patent Application Nos. 62/257,722, filed Nov. 20, 2015; 62/275,043, filed Jan. 5, 2016; and 62/318,762, filed Apr. 5, 2016.

Further, the present application is also a continuation-in-part of application Ser. No. 18/474,130, filed Sep. 25, 2023, which is a continuation of application Ser. No. 17/484,779, filed Sep. 24, 2021, which is a continuation of application Ser. No. 15/441,239, filed Feb. 24, 2017, which is a continuation-in-part of application Ser. No. 15/391,837, filed Dec. 27, 2016, which is a continuation-in-part of application Ser. No. 15/356,512, filed Nov. 18, 2016, which claims benefit of provisional Application Nos. 62/257,722, 62/275,043, and 62/318,762, filed Nov. 20, 2015, Jan. 5, 2016, and Apr. 5, 2016, respectively. All of the foregoing applications are incorporated by reference herein.

### BACKGROUND

Unless otherwise indicated herein, the materials described in this section are not prior art to the claims in this application and are not admitted to being prior art by inclusion in this section.

### FIELD OF INVENTION

The subject matter in general relates to data processing. More particularly, but not exclusively, the subject matter relates to a system and method for content and action recommendation based on user behaviour, and other matters.

### DISCUSSION OF RELATED ART

Smartphones have become commonplace and are being used for a wide variety of applications, such as getting information on a variety of subjects, communication and e-commerce, among others. Some of these applications, based on user activity, can recommend content to the user. As an example, FACEBOOK may recommend content based on activities of the user on FACEBOOK. Further, some of these applications are hardcoded to recommend actions. As an example, FACEBOOK may recommend uploading recently captured photos. However, such action recommendations are not customized, and consequently, may lead to inferior user experience.

Additionally, with an increase in the dependence on mobile applications, users often prefer online shopping over visiting brick and mortar stores. Some of these ecommerce applications use Augmented reality (AR) to enable visualization. For example, if the user wants to purchase a sofa set for a living room, using augmented reality, the user can visualize the sofa set in the living room. However, for this the user will have to choose a sofa set from furniture category of the ecommerce app, point the mobile camera at their living room and move the sofa set to the required space. These steps can be tedious and time consuming for a user.

Further, with the development in mobile technology, users prefer the mobile applications to complete the user instructions without the need for manually entering the user instruction in the applications. Some of these applications use virtual agent for enabling the user instructions. For example, the virtual agent may be triggered by hot keywords from the user's voice instruction to complete the intent of the user. However, the virtual agent can only be triggered by the user's speech and may not use the previous information about the user to generate content recommendations to complete user instructions in an application.

### SUMMARY

In one aspect, a system is provided for recommending actions on a device. The system includes at least one processor configured to record actions, which are performed by a user on the device, across a plurality of applications present on the device. The processor develops a personalized model, which is specific to a user of the device, for recommending actions, wherein the personalized model is at least based on the recorded actions. The processor recommends a follow on action to be carried out on a second application after a first action is carried out on a first application based on the personalized model.

In another aspect, the processor is configured to function as a virtual agent, wherein the virtual agent provides instruction to the second application to carry out the follow on action. In another aspect, the processor can be configured to function as a general virtual agent, wherein the general virtual agent can act on behalf of the user in accordance with the personalized model of the user.

In another aspect, the second application enables augmented reality, wherein the processor is configured to enable at least virtual placement of an item within a display depicting a real world scene. In another aspect, the processor can be configured to provide a general virtual assistant, such as a general virtual assistant that can assist the user with using augmented reality functions on a device.

The present invention provides computer-implemented methods, systems, and computer-readable media for usage recall and cross-application task execution on a user device. The invention enables a computing device to observe, learn from, and reproduce prior user activity across different applications, using a combination of visual content capture, neural-network-based analysis, and natural-language retrieval.

In one embodiment, a method is disclosed for usage recall on a user device. The method includes capturing, at periodic intervals, visual content displayed on the user's screen, and analyzing the captured content by dividing it into pixels and processing those pixels with a neural network trained to recognize visual elements and their spatial relationships. From this analysis, the system generates an element map identifying the positions of user-interface components such as buttons, menus, input fields, and links. Each captured frame is stored in a local context store together with its timestamp, application or window identifier, and descriptors of the recognized elements. Detected text within the captured content is tokenized and indexed with the corresponding entry.

Upon receiving a natural-language query describing a past activity (for example, “open the spreadsheet I edited yesterday” or “show me the article I was reading”), the system parses the query into tokens, compares them with stored descriptors and recognized text tokens, retrieves the most relevant stored entry, and programmatically re-establishes the prior application state. This is accomplished by generating synthetic user-interface events-such as pointer, touch, keyboard, or accessibility actions-targeted to the visual elements identified in the element map, without invoking application-specific deep links or intents. Consequently, the system restores prior context and enables task continuation across applications solely through learned user-interface semantics.

In another embodiment, a cross-application task execution method extends this framework. The device analyzes current on-screen visual content together with recorded behavioral sequences to determine a user's intention for a present task. A universal virtual agent plans and executes a sequence of actions across multiple applications by emitting operating-system-level input primitives directed to recognized interface elements. The planning process may include combining the neural network's visual understanding with a user profile vector representing historical behavior or group preferences.

The present invention further extends the neural architecture supporting these functions. The system's analysis of visual content employs a Deep Neural Network (DNN) trained to extract hierarchical spatial features for accurate element recognition. Temporal and behavioral dependencies between successive frames or actions are modeled by a Recurrent Neural Network (RNN) trained on sequential interaction data. In certain embodiments, the RNN incorporates Long Short-Term Memory (LSTM) cells arranged in an encoder-decoder architecture with an attention mechanism trained through gradient-descent backpropagation. The encoder receives time-series input vectors combining image features, recognized text tokens, and contextual metadata, while the decoder generates predicted output tokens representing search queries, interface actions, or content items.

To determine the most relevant actions or recommendations, the predicted tokens are supplied to a ranking module comprising a deep feed-forward neural network configured to rank candidate outputs according to probability of relevance or popularity. The system further employs reinforcement-learning algorithms, including Deep Reinforcement Learning (DRL), which optimize ranking and retrieval accuracy through feedback derived from user selections. The DRL framework models agent, action, state, and reward interactions, assigning positive rewards when a user accepts or confirms a retrieved result and negative rewards when rejected, thereby improving subsequent recall and prediction accuracy over time.

### BRIEF DESCRIPTION OF THE DIAGRAMS

This disclosure is illustrated by way of example and not limitation in the accompanying figures. Elements illustrated in the figures are not necessarily drawn to scale, in which like references indicate similar elements and in which:

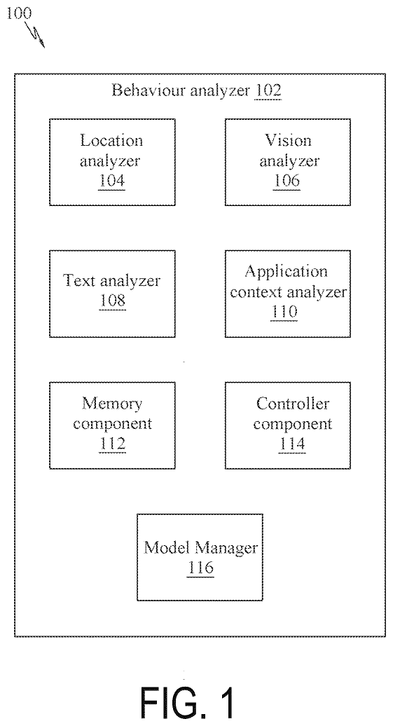

FIG. 1 is an exemplary block diagram illustrating software modules of a system 100 for recommending content and actions based on user behaviour, in accordance with an embodiment.

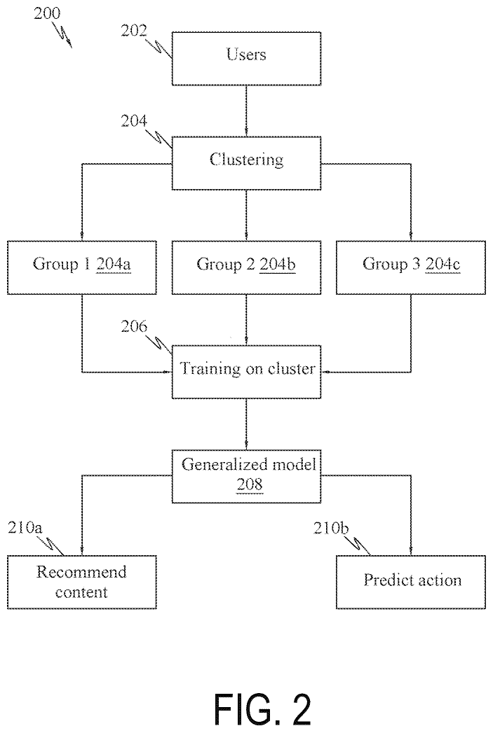

FIG. 2 is a flowchart 200 illustrating the steps involved in building a generalized model 208 a, in accordance with an embodiment.

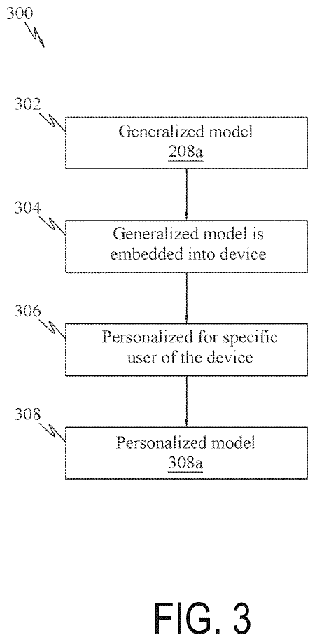

FIG. 3 is a flowchart 300 illustrating the steps involved in building a personalized model 308 a of the behaviour analyzer 102, in accordance with an embodiment.

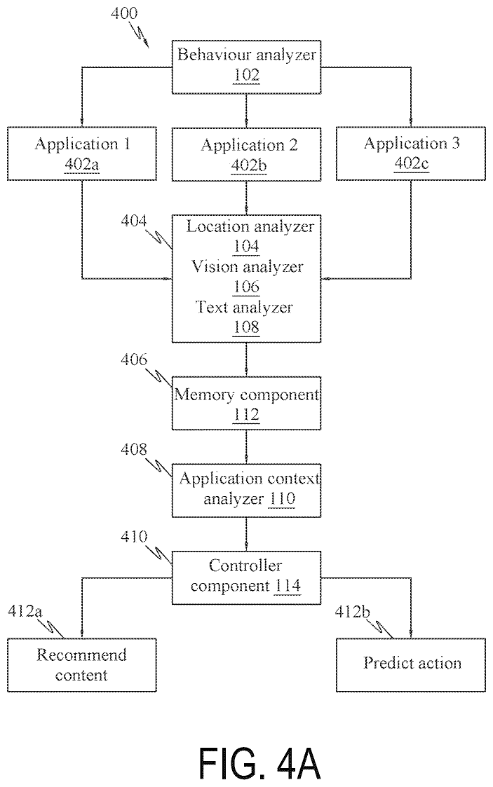

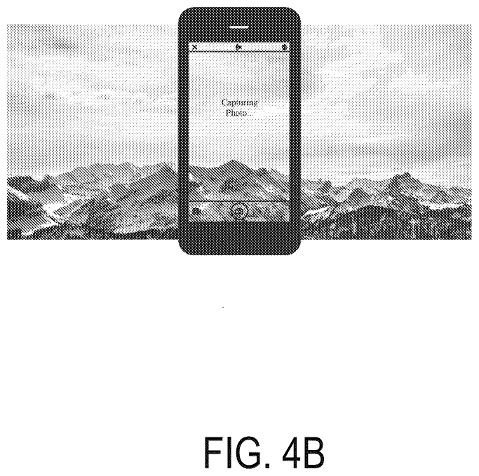

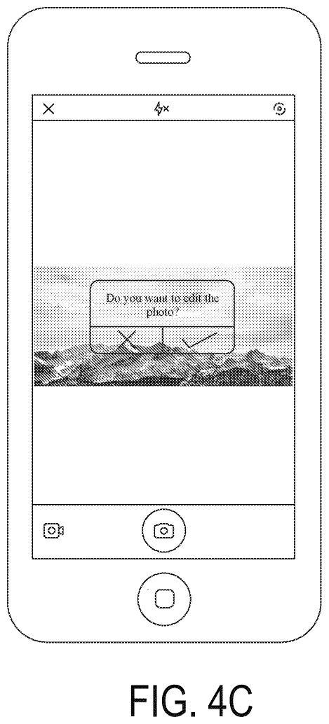

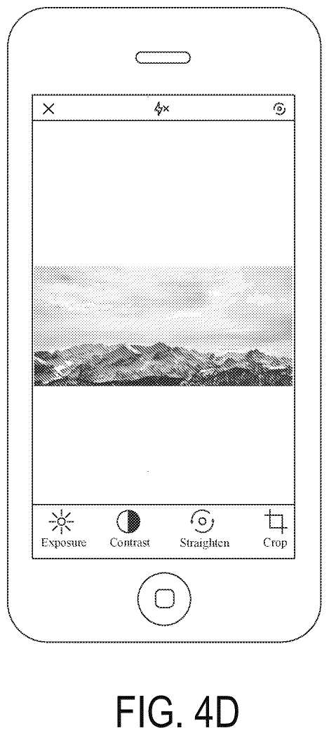

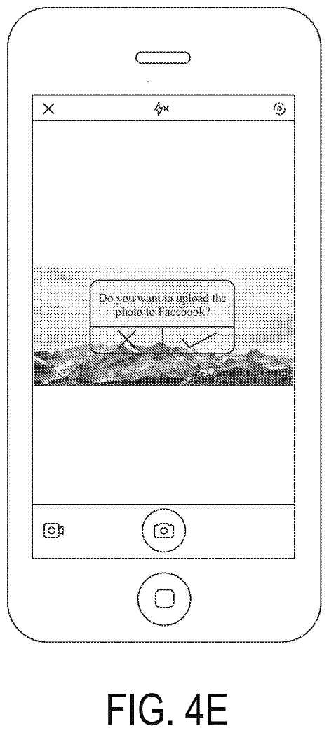

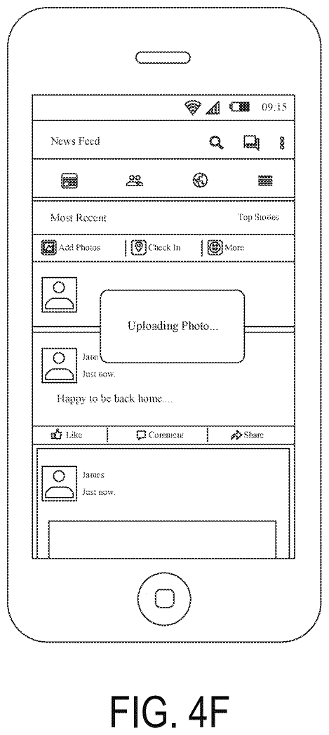

FIG. 4A is a flowchart 400 of an exemplary method for recommending content and predicting user actions, by the behaviour analyzer 102, in accordance with an embodiment.

FIG. 4B, FIG. 4C, FIG. 4D, FIG. 4E, and FIG. 4F illustrate user interfaces enabled by the behaviour analyzer 102, in accordance with an embodiment.

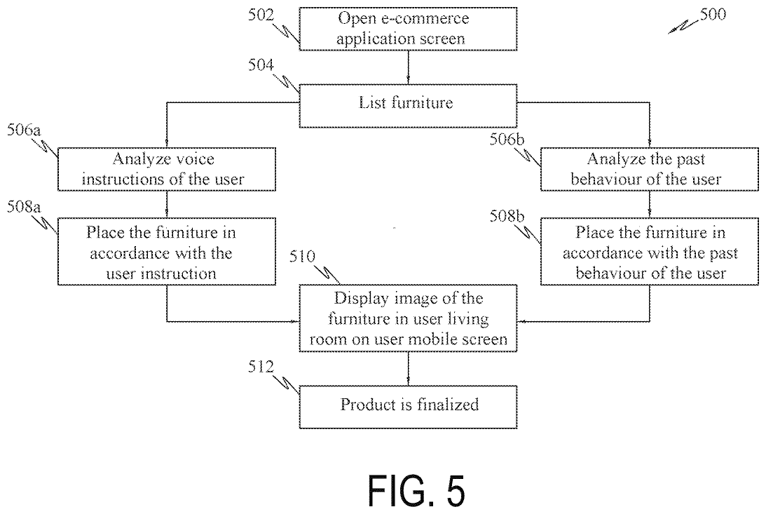

FIG. 5 is a flowchart of an exemplary method 500 enabled by a virtual agent facilitated by the behaviour analyzer 102, in accordance with an embodiment.

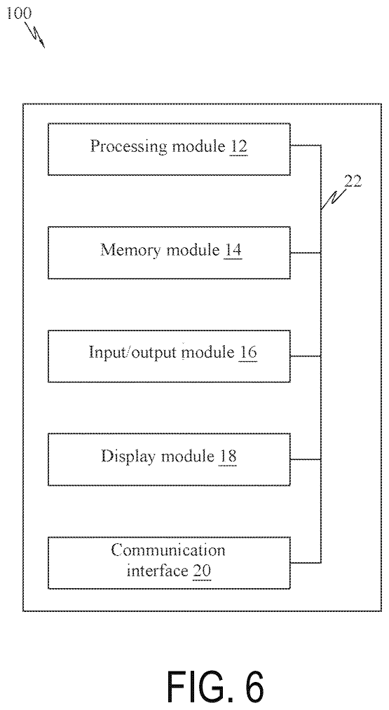

FIG. 6 is a block diagram illustrating hardware elements of the system 100 of FIG. 1, in accordance with an embodiment.

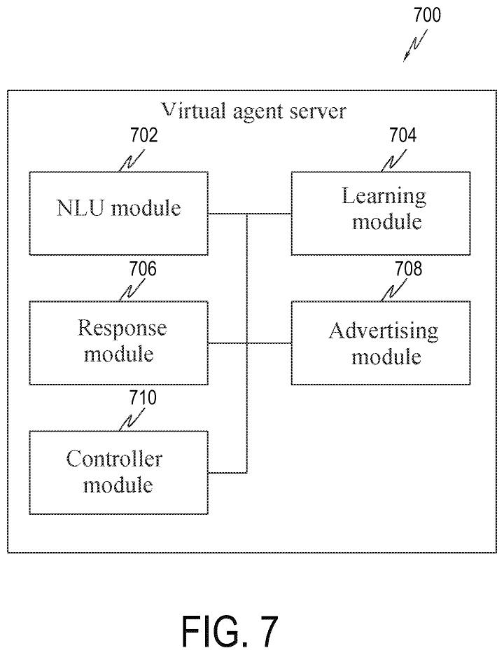

FIG. 7 depicts an exemplary architecture of a virtual agent server 700, in accordance with an embodiment;

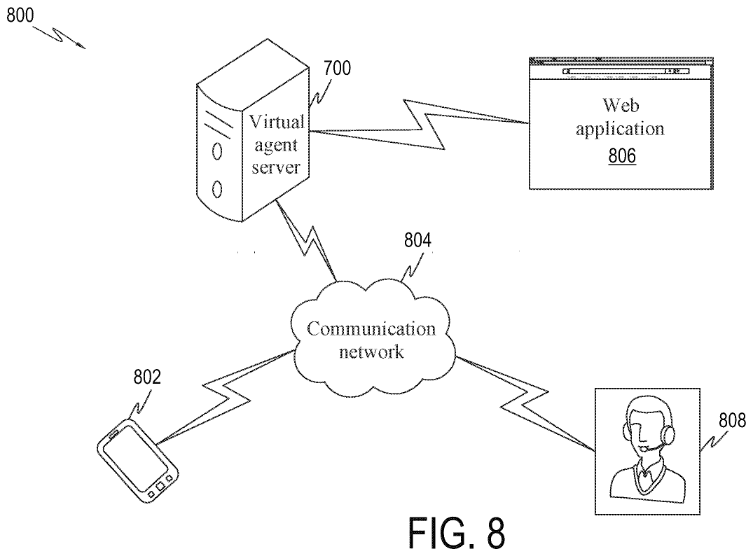

FIG. 8 depicts a system 800 including the virtual agent server 700 for assisting in conversational marketing, in accordance with an embodiment;

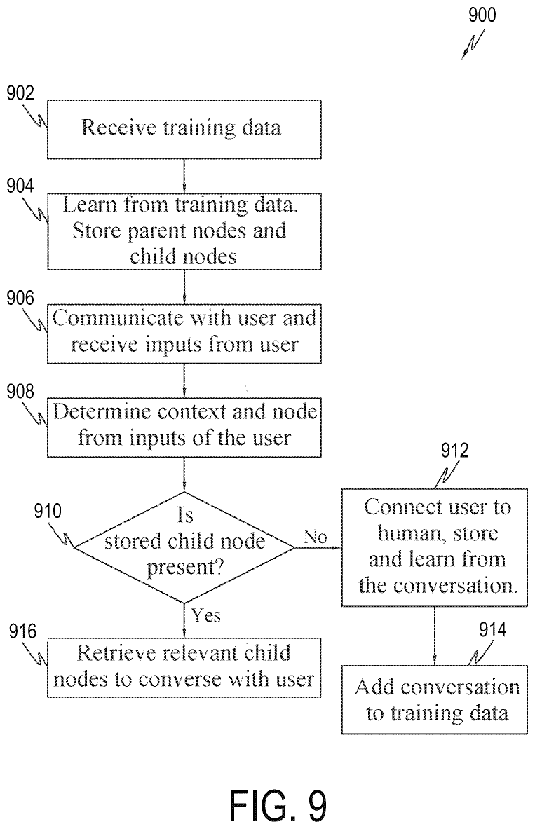

FIG. 9 depicts a flowchart of an exemplary method 900 for interactive advertisement with a user, in accordance with an embodiment;

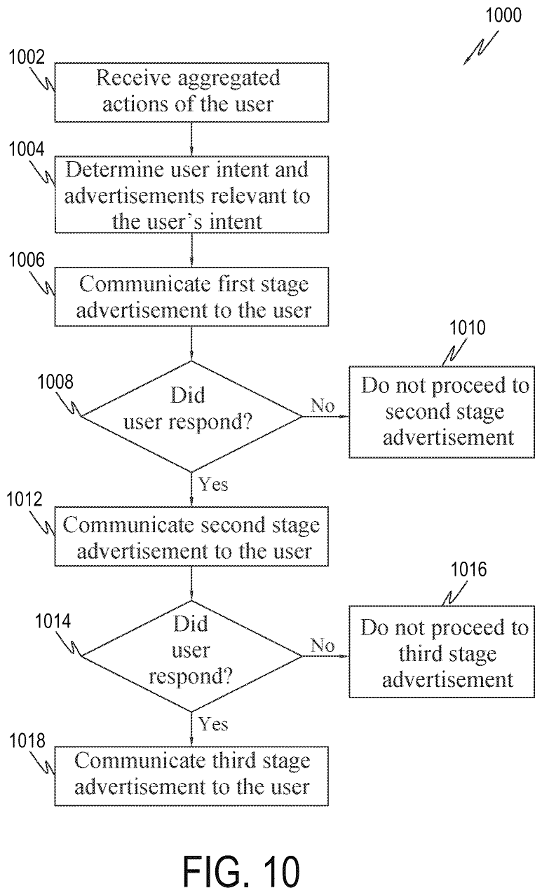

FIG. 10 depicts a flowchart of an exemplary method 1000 for communicating advertisements to a user, in accordance with an embodiment; and

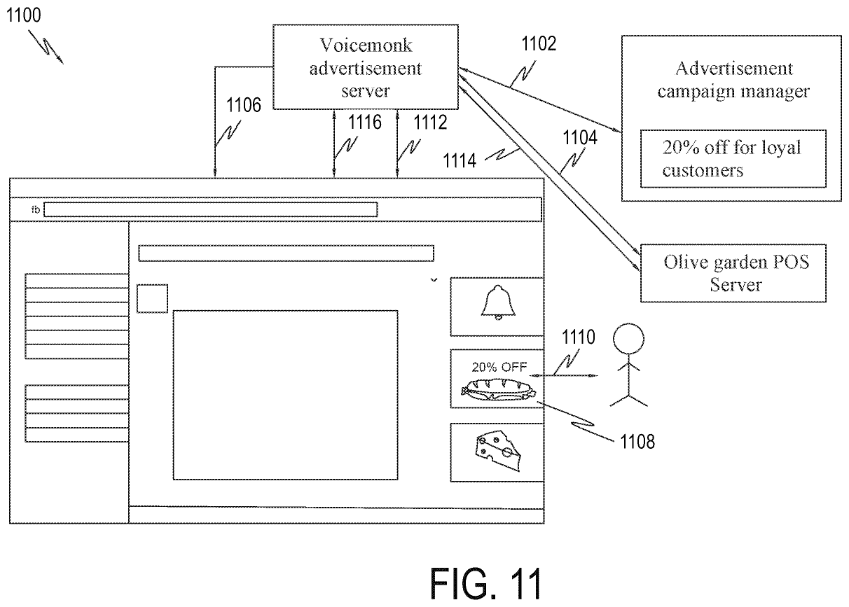

FIG. 11 depicts a flow diagram of an exemplary method 1100 for communicating advertisements to a user through actionable marketing, in accordance with an embodiment.

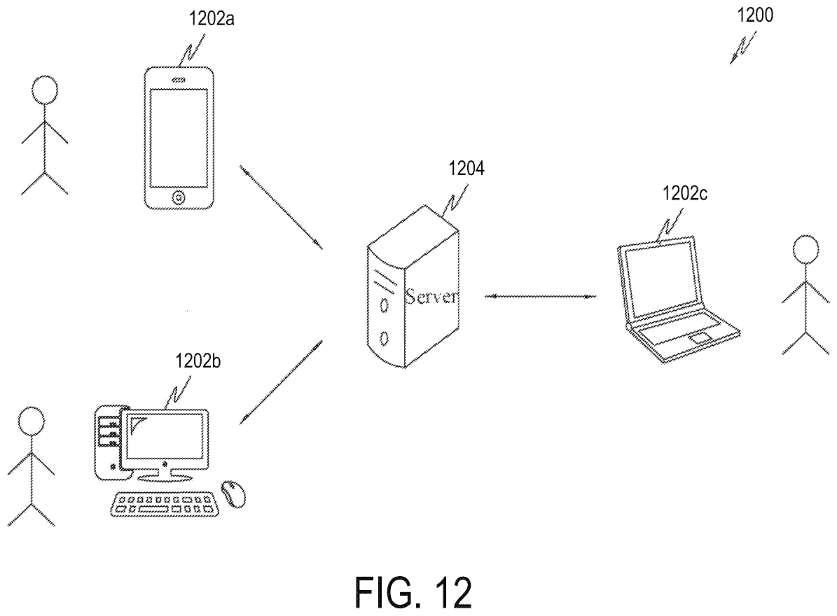

FIG. 12 illustrates an exemplary architecture of a system 1200 for generating search tokens for a user, in accordance with an embodiment;

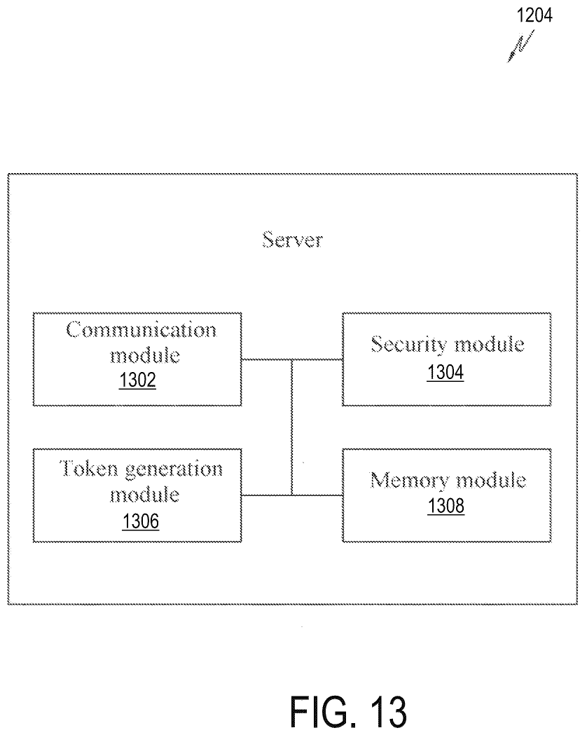

FIG. 13 illustrates an exemplary block diagram 1300 of a server 1204, in accordance with an embodiment;

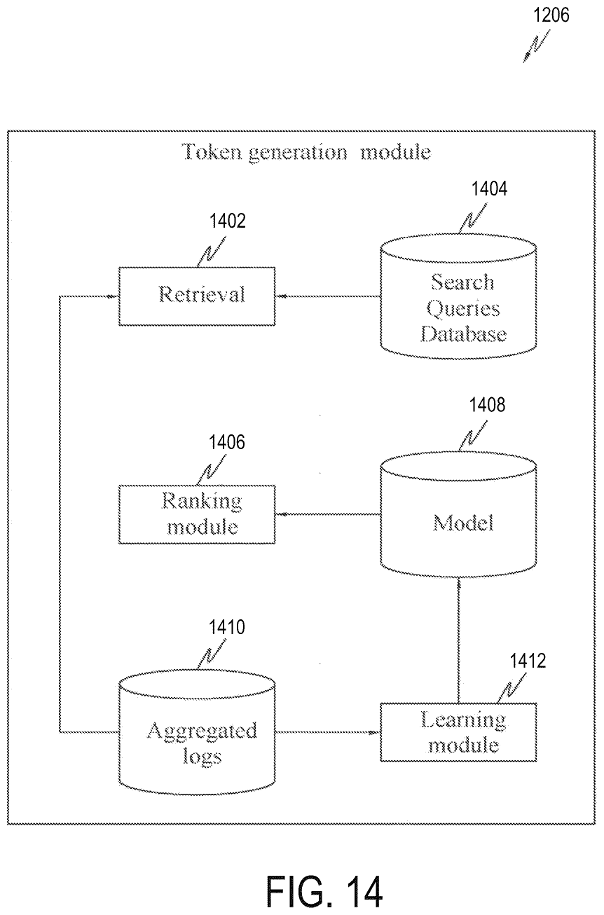

FIG. 14 illustrates an exemplary block diagram 1400 of a token generation module 1306 for the system 1200, in accordance with an embodiment;

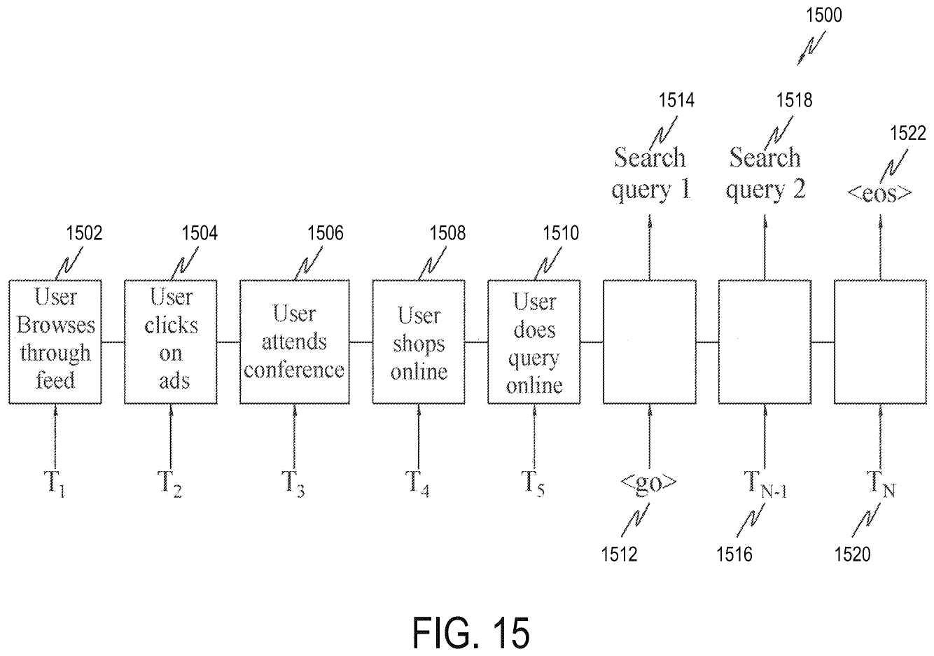

FIG. 15 illustrates an exemplary block diagram 1500 for a behavior-to-search model for the system 1200, in accordance with an embodiment;

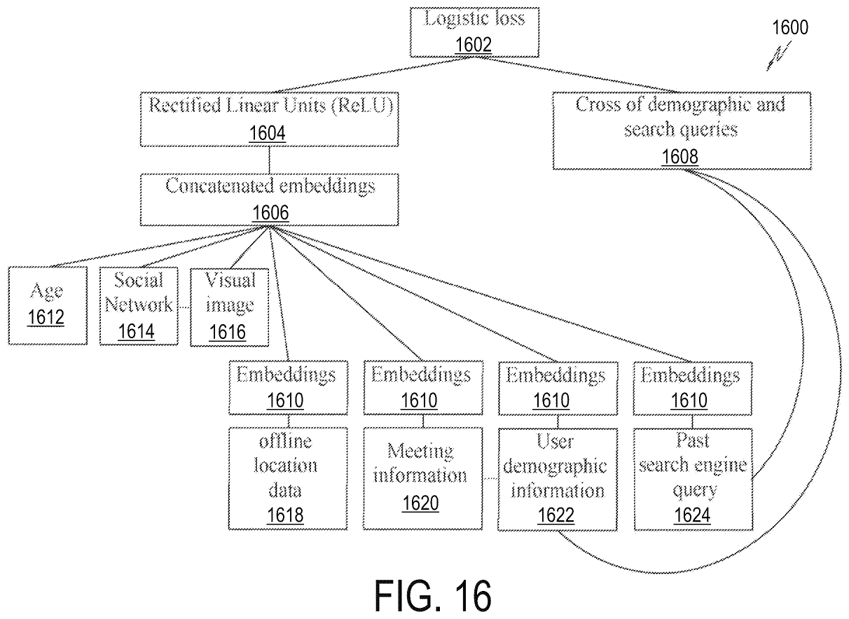

FIG. 16 illustrates an exemplary block diagram 1600 for a wide and deep neural network for the system 1200, in accordance with an embodiment;

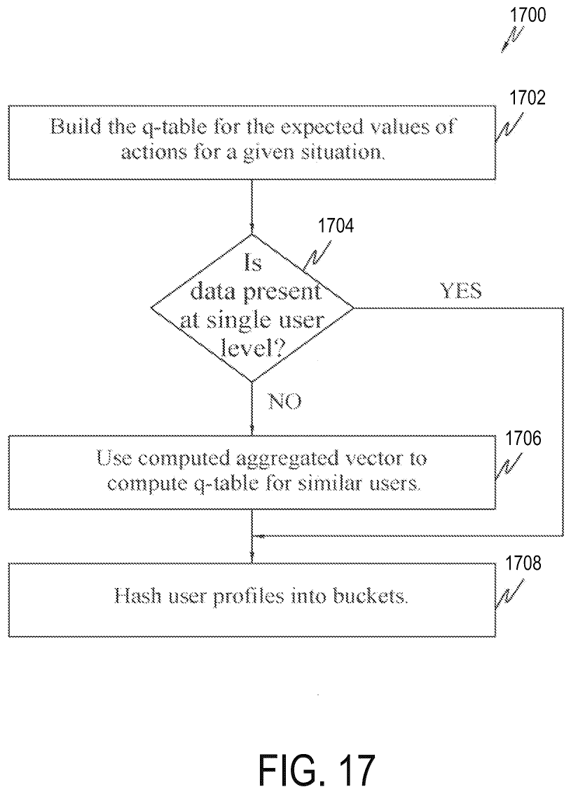

FIG. 17 illustrates an exemplary flow diagram 1700 depicting a method for using aggregated user behavior using the system 1200, to enrich Deep Reinforcement Learning algorithms for the system 1200, in accordance with an embodiment; and

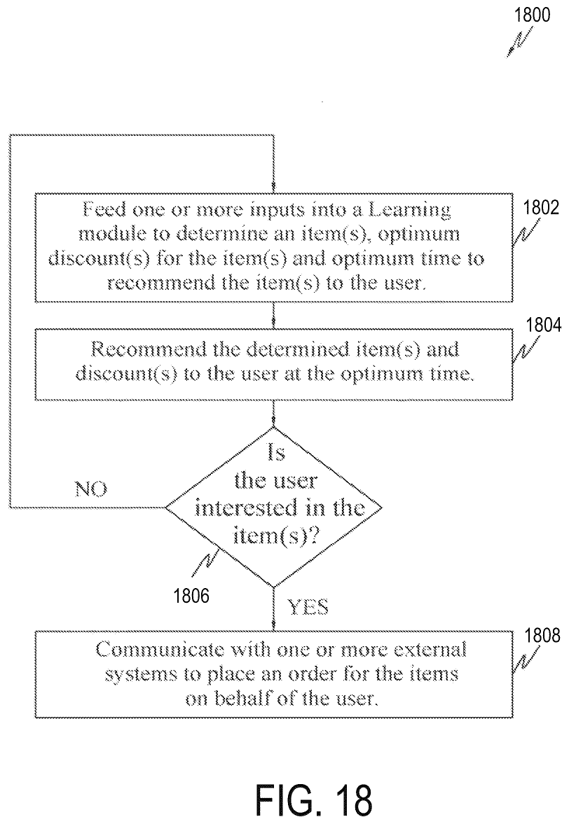

FIG. 18 illustrates an exemplary flow diagram 1800 depicting a method for generating a hyper-personalized marketing message for the system 1200, in accordance with an embodiment.

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

Referring to FIG. 1, a system 100 is provided for generating content and recommending actions. The system 100 is configured to generate content and recommend actions on a user device using a behaviour analyzer 102.

The behaviour analyzer 102 may be configured to learn the behaviour of a user of a device. The behaviour analyzer 102 may learn the behaviour of the user by continuously studying the interactions of the user with the device. The behaviour analyzer 102, may form a hypothesis on the activities of the user by continuously learning from the user interactions with different applications installed on the device and may generate content in a timely manner. The activities may include calling an individual, texting the individual after the phone call, capturing a photo, updating the photo on a social media, ordering food online and so on. The different applications installed on the device may be calling applications, messaging applications, call recorder, social media applications like FACEBOOK, INSTAGRAM, WHATSAPP and so on, online food ordering applications like SWIGGY, ZOMATO and so on. The device may be a mobile 414. As an example, a user may use the device to capture a photo using a photo capturing application. If the user generally posts the photo using another application, such as a social networking application, after capturing the photo, then there is a high probability that the user will share the currently captured photo on the social networking application. The behaviour analyzer 102 may have already learned about this behaviour of the user and would suggest the user to upload the photo on to the social networking application, after the photo is captured.

In an embodiment, to learn the user behaviour and predict the user actions, the behaviour analyzer 102 may have a location analyzer 104, a vision analyzer 106, a text analyzer 108, an application context analyzer 110, a memory component 112, a controller component 114 and a model manager 116.

The location analyzer 104 may be configured to identify the location of the user/device and the characteristics of the location. As an example, the location analyzer 104 may implement a triangulation method to determine the location of the user and may use available meta data around the location data to determine the characteristics of the location. The metadata may be an event entered by the user in the calendar application. The event may be a conference to be attended by the user on a specific date. As an example, the location analyzer 104 may determine that the user is in a conference room, based on the identified location and the metadata information from the calendar.

The vision analyzer 106 may be configured to analyse the images captured by the camera installed on the user device and the associated metadata. The metadata may be a birthday event, a picnic spot and so on. The vision analyzer 106 may also analyse the device screen. The vision analyzer 106 may break down the device screen into a series of pixels and then pass these series of pixels to a neural network. The neural network may be trained to recognize the visual elements within the frame of the device. By relying on a large database and noticing the emerging patterns, the vision analyzer 106 may identify position of faces, objects and items, among others, in the frame of the device. The vision analyzer 106 may thus act as the “human eye” for the device.

The text analyzer 108 may be configured to parse text in order to extract information. The text analyzer 108 may first parse the textual content and then extract salient facts about type of events, entities, relationships and so on. As an example, text analyzer 108 may identify the trend of messages the user may send to specific people.

The application context analyzer 110 may be configured to analyse the past behaviour of the user. For the behaviour analyzer 102 to predict the actions of the user, the past behaviour of the user should be studied. As an example, the user may call (using a first application) an individual. After the call ends, the user may send a text (using a second application) this individual. This series of behaviour (calling and then texting) may be repeated majority of the times the user makes phone calls to this specific person. The application context analyzer 110 may analyse this series of past behaviour of the user. The output of the application context analyzer 110 is to determine how the past behaviour of the user of the device will impact his future actions. The memory component 112 may be configured to store the previous events/actions corresponding to the user. In context of the above example, the series of actions spread across multiple applications, of the user (calling and then texting) may be stored in the memory component 112.

The controller component 114 may be configured to coordinate with the location analyzer 104, the vision analyzer 106, the text analyzer 108, the application context analyzer 110 and the memory component 112 to gather information of the behaviour of the user to predict the content and actions for the user.

The model manager 116 may manage a personalized model 308 a that is built for a specific user of the device. The model manager 116 may also learn to manage the behaviour of a new user of a device. The behaviour analyzer 102 may be personalized to predict the content and actions according to the individual's behaviour. The behaviour of one user may be different from that of another. As an example, a specific user may upload the photo captured (using first application) to a social media application (a second application) without editing (using a third application) the photo. Another user may upload the picture after editing them. The model manager 116 may be trained to learn the particular behaviour of the user of the device to personalize the behaviour analyzer 102. The model manager 116 may learn from the feedback on the content and action recommendations of the user.

The behaviour analyzer 102 may be implemented in the form of one or more processors and may be implemented as appropriate in hardware and software. Referring to FIG. 6, software implementations of the processing module 12 may include device-executable or machine-executable instructions written in any suitable programming language to perform the various functions described herein. The behaviour analyzer 102 can run as offline process, whenever the user starts an application or as a process which executes every ‘x’ minutes or so. The number ‘x’ can be a configurable parameter.

A generalized model 208 a may be trained based on a user cluster. The generalized model 208 a may be introduced in the user device. The model manager 116 of the behaviour analyzer 102 may then personalize the generalized model 208 a. As an example, as per a generalized model, the users of a specific cluster may capture a photo (using a first photo capturing application), edit the photo (using a second editing application) and uploading the edited photo to a first social networking application (using a third application). Whereas, a personalized model for a specific user could be, capture a photo (using the first photo capturing application), edit the photo (using the second editing application) and uploading the edited photo to a second social networking application (using a fourth application). In an embodiment, the model manager 116 may initialize the generalized model 208 a either during device setup or as part of the booting process.

Having discussed about the various modules involved in predicting the actions of the user and recommending content, the different implementations of the behaviour analyzer 102 is discussed hereunder.

The behaviour analyzer 102 may generate content and recommend actions for the user based on the past behaviour of the user. A generalized model 208 a may be trained on the user cluster. The generalized model 208 a may be trained for a group of users with similar profile. The generalized model 208 a may then be personalized for a specific user of the device, which may be called as personalized model 308 a. The behaviour analyzer 102 may record actions of the user, to personalize the generalized model 208 a. The actions may be performed across plurality of applications installed on the device. The personalized model 308 a may recommend actions based on the recorded actions and may recommend a follow on action to be carried out on a second application. As an example, the follow on action may be uploading a photo on a social networking application (second application) after the photo is captured using a mobile camera application (first application).

Referring to FIG. 2, at step 204, the users may be clustered using a learning algorithm. The clustering of the users may result in generation of different user clusters, group 1 204 a, group 2 204 b and group 3 204 c. The generalized model 208 a may then be trained using a Neural network on the training data for the user clusters. Referring to step 210 a and 210 b, the trained generalized model 208 a may recommend content and predict actions for the users of specific clusters using a prediction algorithm.

Having provided an overview of the steps involved in building the generalized model 208 a, each of the steps is discussed in greater detail hereunder.

In an embodiment, referring to FIG. 2, at step 204, the users can be clustered using the learning algorithm. The learning algorithm may be K-means clustering algorithm. K-means clustering groups an unlabelled data. An unlabelled data includes data without defined categories or groups. All of the users may form the unlabelled data. The K-means clustering algorithm find groups in the unlabelled user data, with the number of groups represented by the variable “K”. The algorithm works iteratively to assign each user (data point) to one of “K” groups based on the features of the user. The users may be clustered based on feature similarities. The features of the user may be age, behavioural characteristics, gender and so on. The output of K-means clustering algorithm may be clusters of users, group 1 204 a, group 2 204 b and group 3 204 c, wherein each cluster may have similar features.

At step 206, the user cluster may be trained using a deep Neural Network on large training data on the users of the cluster. The user cluster may be trained using the training data from the location analyzer 104, the vision analyzer 106, the text analyzer 108, the application context analyzer 110 and the memory component 112 within the user cluster. As an example, the user cluster may be trained to upload a photo on FACEBOOK using training data. The location analyzer 104 may have data about the location of the picture, the vision analyzer 106 may have the image that has to be uploaded, the application context analyzer 110 may have the data pertaining to the behaviour (uploading photo) of the cluster and this data may be stored in the memory component 112.

At step 208, the trained user cluster may form the generalized model 208 a for specific user cluster. At step 210 a and 210 b, the generalized model 208 a after learning the behavioural pattern of the cluster may recommend content and predict actions for the cluster based on the behavioural pattern of the cluster. In an embodiment, the generalized model 208 a may predict a sequence of actions for the user cluster by using a Recurrent Neural Network (RNN). RNN algorithm is designed to work with sequence predictions. Sequence is a stream of data which are interdependent. RNN algorithm will have an input loop, an output loop and hidden layers between the input loop and the output loop. The output from a previous step will be taken as input for a current step. In this way RNN creates a network of input loops, process these sequence of inputs that are dependent on each other to predict the final output sequence. The generalized model 208 a may continuously learn from the behavioural pattern of the cluster. As an example, the user may have a behavioural pattern of capturing a photo, editing the photo after capturing, uploading the photo on FACEBOOK and then sharing the same on INSTAGRAM. The RNN algorithm will process this sequence. The next time the user captures a photo and edit them, the generalized model 208 a will recommend the user to upload the photo on FACEBOOK and then to share the same on INSTAGRAM. In an embodiment, the generalized model 208 a may predict application actions for the user cluster by using a Deep Neural Network (DNN). The application actions may be sending a SMS (Short Message Service) to a friend, calling a merchant and so on.

Referring to FIG. 3, at step 304, the trained generalized model 208 a of the behaviour analyzer 102 may be embedded into the user device. The user may have carried out different actions across different application installed on the device before the generalized model is embedded on the device. When the generalized model 208 a is embedded on the device, these sequence of actions may be learned by the generalized model 208 a. The sequence of actions may be specific to a specific user of the device. The embedded generalized model 208 a may thus be personalized for the specific user of the device, at step 306. The personalization of the generalized model 208 a may generate a personalized model 308 a (step 308). The personalized model 208 a may predict follow up actions based on the sequence of actions of the user.

In an embodiment, the personalization of the behaviour analyzer 102 may be implemented using the learning algorithm. The learning algorithm may be Reinforcement Learning. Reinforcement Learning uses the concept of agent, actions, states and reward to attain a complex objective (content recommendation and action for the user of the device). As an example, the aggregated user behaviour, updates from the social media may be the state for the user. Content recommendation, displaying an application action may be the action of the algorithm. Correctly predicting the action at time “t” may be the reward function. In Reinforcement Learning, the agent (behaviour analyzer 102) may be provided with the state. The agent may then take an action for the corresponding state. If the agent is successful in predicting the action at time “t”, then the agent will be rewarded with positive points (“+1”). If the agent is unsuccessful in predicting the action at time “t”, then the agent will be punished with negative points (“−1”). The agent will try to maximize the cumulative reward functions to achieve the best possible action. To figure out the action, the behaviour analyzer 102 may implement policy learning algorithm. As an example, the behaviour analyzer 102 may recommend uploading a picture using a social networking application after capturing the picture. In case the user accepts the recommended action, then the behaviour analyzer 102 may be awarded a positive point. Else, the behaviour processor 102 may be awarded a negative point. The behaviour analyzer 102 may attempt to maximize the positive point to correctly predict the action of the user next time the user captures a photo. The personalized model 208 a may maximize the positive points based on the acceptance (positive points) or rejection (negative points) of the actions recommended by the behaviour analyzer 102. As an example, if the user accept to upload the photo after capturing the photo, the behaviour analyzer may be rewarded with a positive point. Whereas, if the user do not upload the photo after capturing the photo, the user may obtain a negative point. Based on these negative and positive points, the personalized model 208 a may be refined. The In another embodiment, the behaviour analyzer 102 may implement value iteration algorithm to figure out the action.

In another embodiment, an End to End Neural Network using an architecture consisting of Policy Gradient Deep Reinforcement Learning on top of a Deep Neural Network (DNN) may be applied. The DNN with attention can generate user behaviour embeddings on the offline user cluster behaviour data. The generic model then can be personalized for the user by adjusting the loss function in the Policy Gradient Deep Reinforcement Learning to predict the user actions.

In yet another embodiment, generalized model 208 a may be trained to do imitation learning for user clusters on the behaviour sequence data. The user behaviour can be trained by implementing one shot learning algorithm.

Referring to FIG. 4A, the behaviour analyzer 102 may continuously learn from interactions of users with the different applications, application 1 402 a, application 2 402 b and application 3 402 c, installed on the mobile 414. As an example, the application 1 402 a may be camera application, the application 2 402 b may be a photo editor and the application 3 402 c may be a social networking application. There may be more than 3 applications. At step 404, the location analyzer 104, the vision analyzer 106 and the text analyzer 108 may collect data and information from the different applications, application 1 402 a, application 2 402 b and application 3 402 c. As an example, the data and information stored may include images captured by the camera application (application 1 402 a), editing behaviour of the user in the photo editor (application 2 402 b), uploading behaviour of the user on the social networking application (application 3 402 c), different events stored in the calendar (application 4 (not shown)), and so on. At step 406, the data and information collected from the application 1 402 a, the application 2 402 b and the application 3 402 c may be stored in the memory component 112. At step 408, the data stored in the memory component 112 may be analysed by the application context analyzer 110. The application context analyzer 110 may analyse the context of the actions in which the user had previously carried out the follow up actions after carrying out a first action. The context of the action may be based on the location of the device where the action is carried out and/or characterizing information associated with the location where the action is carried out and/or the time at which the action is carried out and/or the scheduled event at the time at which the action is carried out. As an example, the user may only upload the photos that are captured, at morning, on a picnic spot and may not upload photos captured at the user's office or any other time. At step 410, the controller component 114 gathers the data and the information to determine the behaviour of the user. At step 412 a and 412 b the controller component 114 may recommend content and predict actions of the user if the context in which the first action is carried out correlates with the context in which the user had previously carried out the follow up action after carrying out the first action. As an example, the controller component 114 may gather the image from the camera application, editing behaviour from the photo editor application, uploading behaviour of user, at different events, from social networking application and event marked in calendar to arrive at the conclusion that the user may upload photos, if the photos are captured at a picnic spot at morning time.

FIG. 4B, FIG. 4C, FIG. 4D and FIG. 4E illustrates an exemplary method of predicting user actions, by the behaviour analyzer 102. Referring to FIG. 4B, the user of the mobile 414 may open camera application (application 1 402 a) to capture photo on New Year. As soon as the user completes capturing the photo, the behaviour analyser 102 may send a pop-up 416 “Do you want to edit the photo?” (FIG. 4C). If the user wishes to edit the photo, he may select “v”.

The behaviour analyzer 102 may open the photo editor application (application 2 402 b) for the user, wherein the user can edit the photo (FIG. 4D). Referring to FIG. 4E, on completion of photo edition, the behaviour analyzer may send another pop-up 418 “Do you want to upload the photo on FACEBOOK?”. If the user wants to upload the photo on FACEBOOK, the user may select “V” on which the behaviour analyzer 102 may upload the photo in the user's FACEBOOK (FIG. 4F). Referring to FIG. 4E, if the user do not wish to upload the photo in FACEBOOK, then he may select “x”, on which the behaviour analyzer 102 may take the user back to the camera application. Referring to FIG. 4C, if the user do not want to edit the photo, then he may select “x”, upon which the behaviour analyzer 102 may send a pop-up 418 “Do you want to upload the photo on FACEBOOK?” (FIG. 4E). The user may select “V” if he wishes to upload the photo in FACEBOOK, on which the behaviour analyzer 102 may upload the photo in the user's account in FACEBOOK (FIG. 4F). If the user do not wish to upload the photo in FACEBOOK, then he may select “x”, on which the behaviour analyzer 102 may take the user back to his camera application.

In conventional methods, to benefit from an application, the user may have to first open the application and then browse through the menu option available in the application. To successfully operate the application, the user should have a basic knowledge about method of operation of the application. Further, on facing any issues in browsing the application, the user may have to call the customer care to resolve the issue. In an embodiment, the behaviour analyzer 102 may act as a virtual agent for the user. The behaviour analyzer 102 may use embodiments mentioned in patent application Ser. No. 15/356,512, which is herein in cooperated by reference, to understand the context of the application and act as the virtual agent. The behaviour analyzer 102 may use the data from the location analyzer 104, the vision analyzer 106, the text analyzer 108, the application context analyzer 110, the memory component 112, the controller component 114 and the model manager 116 to extract information on the application context and may learn the intentions of the user from the user's past behaviour. The application context may include information about text and images in the applications, the contents in the application which the user is interested in and so on. Based on these, the behaviour analyzer 102 may answer questions about the services in the application. The behaviour analyzer 102 may also do actions on the application, on behalf of the user. The behaviour analyzer 102 may interact in natural language with the application. As an example, the user may be interested in ordering food online. The behaviour analyzer 102 may filter food in accordance with the past behaviour of the user. The behaviour analyzer 102 may also do other action such as placing the order, choosing the payment options, making payment and so on.

In an embodiment, the behaviour analyzer 102 may use imitation learning algorithm to execute actions in the application. Imitation learning algorithm take behavioural pattern of the user as input and will replicate the behaviour of the user to execute actions on behalf of the user. In another embodiment, the behaviour analyzer may execute actions on behalf of the user by implementing one shot learning. One shot learning require minimum amount of data as input to learn the behaviour of the user.

The behaviour analyzer 102 may act as a virtual agent for the ecommerce applications. The user of the ecommerce application, before purchasing a product may want to see how the product may look in a suitable environment. Such an experience is possible by Augmented reality. Augmented reality is an interactive experience of a real-world environment whereby elements of the virtual world is brought into the real world for enhancing the environment that the user experience. As an example, the user may purchase a sofa set from an ecommerce application such as AMAZON, FLIPKART and so on. In conventional approach, the user may have to choose the sofa set from the ecommerce application, open the camera application installed on user's mobile, point the camera at living room, drag the sofa set and then place the sofa set on the desired location to get a physical sense of how the sofa set fits in user's living room. The user may want to see how the product fits in his living room before finalizing on the product.

In an embodiment of the subject matter disclosed herein, the behaviour analyzer 102 may place the sofa set in the user's living room, on his mobile screen, to give a physical sense of how the sofa set looks in his living room.

In an embodiment, the behaviour analyzer 102 may act as a virtual agent, for executing the Augmented reality, for the ecommerce applications by first understanding the action and then completing the action. As an example, the action may be placing the sofa set on the user's living room.

In an embodiment, the behaviour analyzer 102 with access of data from the location analyzer 104, the text analyzer 108, the application context analyzer 110, the memory component 112, the controller component 114 and the model manager 116 may act as a virtual agent for the ecommerce application. The virtual agent may take the voice input of the user, convert the voice to text to understand the action intended by the user. Other information elements required for understanding the action may be figured out using slot filing algorithm. In an embodiment, additional context that may be helpful for the virtual agent may be provided manually by the user. The additional context may include bitmap of the physical visual images captured by the camera of the device, textual description of the image and so on.

In an embodiment, the virtual agent may be trained to understand the virtual image in an ecommerce application (example: Sofa set), the title and the category of the image, the physical context and the natural language utterance by implementation of Neural module network.

After understanding the actions, the behaviour analyzer 102 as an agent may need to complete the action. As an example, the behaviour analyzer 102 may move the sofa set from one corner of the living room to the other corner. The action can be completed by the virtual agent, manually, by taking the input given by the user in natural language voice input. The user may give input to the virtual agent, which in turn may convert the natural language voice input to text input and then complete the action.

In an embodiment, the virtual agent may complete the actions by itself. The virtual agent may be trained by Deep Neural Network algorithm to automatically complete the actions. In an embodiment, Deep Reinforcement Learning approach on top of Neural Modules may be used for natural language understanding, object detection and scene understanding to execute actions.

As an example, referring to FIG. 5, at step 502, the user opens an e-commerce application. The user may browse through different products available on the application and at step 504, the user may select a furniture for the user's living room. After the selection of the furniture, the user may provide voice instructions to the behaviour analyzer 102 for placing the furniture in the living room (step 506 a-step 508 a). Alternatively, the behaviour analyzer 102 may analyse the past behaviour of the user and suggest placing the furniture in the living room on behalf of the user (step 506 b-508 b).

In an embodiment, at step 506a, the user may give voice instructions to the behaviour analyzer 102. The voice instructions of the user may be converted to text by the behaviour analyzer 102 to understand the intent of the user. At step 508 a, the behaviour analyzer 102 may place the furniture in accordance with the instruction provided by the user, in the image of the living room as displayed in the mobile screen of the user. At step 510, the user may get a visual experience of the furniture in the living room. If the user is satisfied with the product, the user may finalize on the product (512) for purchase.

In an embodiment, at step 506 b, the behaviour analyzer 102 may analyse the past behaviour of the user to complete the action intended by the user. At step 508 b, the behaviour analyzer 102 may place the furniture in the living room, in accordance with the past behaviour of the customer. At step 510, the user may get a visual experience of the furniture placed in the living room, on his mobile. If the user is satisfied with the product, at step 512, the user may finalize the product for purchase.

In another embodiment, the virtual agent may execute actions by training the virtual agent by implementation of Imitation learning.

Having provided the description of the different implementations of the system 100 for predicting the actions of the user and recommending contents based on user behavior, hardware elements of the system 100 is discussed in detail hereunder.

FIG. 6 is a block diagram illustrating hardware elements of the system 100 of FIG. 1, in accordance with an embodiment. The system 100 may be implemented using one or more servers, which may be referred to as server. The system 100 may include a 20 processing module 12, a memory module 14, an input/output module 16, a display module 18, a communication interface 20 and a bus 22 interconnecting all the modules of the system 100.

The processing module 12 is implemented in the form of one or more processors and may be implemented as appropriate in hardware, computer executable instructions, firmware, or combinations thereof. Computer-executable instruction or firmware implementations of the processing module 12 may include computer-executable or machine-executable instructions written in any suitable programming language to perform the various functions described.

The memory module 14 may include a permanent memory such as hard disk drive, may be configured to store data, and executable program instructions that are implemented by the processing module 12. The memory module 14 may be implemented in the form of a primary and a secondary memory. The memory module 14 may store additional data and program instructions that are loadable and executable on the processing module 12, as well as data generated during the execution of these programs. Further, the memory module 14 may be a volatile memory, such as a random access memory and/or a disk drive, or a non-volatile memory. The memory module 14 may comprise of removable memory such as a Compact Flash card, Memory Stick, Smart Media, Multimedia Card, Secure Digital memory, or any other memory storage that exists currently or may exist in the future.

The input/output module 16 may provide an interface for input devices such as computing devices, keypad, touch screen, mouse, and stylus among other input devices; and output devices such as speakers, printer, and additional displays among others. The input/output module 16 may be used to receive data or send data through the communication interface 20.

The input/output module 16 can include Liquid Crystal Displays (OLCD) or any other type of display currently existing or which may exist in the future.

The communication interface 20 may include a modem, a network interface card (such as Ethernet card), a communication port, and a Personal Computer Memory Card International Association (PCMCIA) slot, among others. The communication interface 20 may include devices supporting both wired and wireless protocols. Data in the form of electronic, electromagnetic, optical, among other signals may be transferred via the communication interface 20.

FIG. 7 depicts an exemplary architecture of a virtual agent server 700, in accordance with an embodiment. The virtual agent server 700 may include a Natural Language Understanding (NLU) module 702 to understand the speech of the user, a learning module 704, a response module 706 to determine responses for the user, an advertisement module 708 and a controller module 710.

In an implementation, the Natural Language Understanding Module 702 (hereafter called NLU module 702) may be used by the virtual agent server 700 to understand the natural speech of the user. In an implementation, the NLU module 702 may receive the user's natural speech as an input. This natural speech may be in the form of audio information or text in a natural language format. Further, the NLU module 702 may parse information from the received natural language speech to determine one or more pieces of information corresponding to the user from the speech of the user. The determined user information may include one or more of the user's desired action and context of the desired action, among others.

In an implementation, one or more inputs may be derived from one or more previous or current communication sessions between two or more among a first user (customer), a second user (customer service representative) and a virtual agent server 700.

In an implementation, the NLU module 702 may use machine learning classification and natural language processing techniques to determine the intent of the conversation. The NLU module 702 may also query a graph which may model conversations on an inverted index to figure out the search intent (as discussed below).

In an implementation, the NLU module 702 may determine the user's intent and use slot filling algorithms to determine different objects in the sentence. The slots associated with the application may be learnt by pattern matching or using neural network technique by feeding slot outputs and conversation inputs from previous interactions.

In an implementation, the learning module 704 may be used by the virtual agent server 100 to receive one or more sets of data to train on. Further, the learning module 104 may use the received training data to learn and store different types of speech or text responses for different situations faced by the virtual agent server 700 while communicating with the user.

In an implementation, the learning module 704 may be configured to receive and process one or more recordings of conversations between a customer service representative and a user. Further, the learning module 704 may convert the conversation between the user and customer service representative from natural speech format to device-readable format. The learning module 704 may use one or more speech-to-text recognition techniques to analyze the conversation for learning and store them in a database for future use. The stored conversations may be used to improve the intelligence of the virtual agent server 700 on a continuous basis by storing the conversations in a graph data structure on an inverted index for efficient retrieval in future conversations.

In an implementation, the learning module 704 may identify and store one or more conversation dialogues as parent nodes. These parent nodes may comprise dialogues spoken by the user that require a response from the virtual agent server 700. Further, the learning module 704 may identify and store one or more dialogues as child nodes which are used as responses corresponding to the one or more identified and stored parent nodes. Elaborating further, in an implementation, a dialogue may be defined by the learning module 704 as the smallest element in a conversation between a user and a virtual agent server 700 or a business organization. A dialogue may be represented by two nodes with an edge between them.

In an implementation, a graph may be constructed manually by an interaction designer, which may then be inserted on inverted index. In yet another implementation, in case a great amount of training data is available to the virtual agent server 700, a recurrent neural network may be trained on the interaction between the customer and the customer service representative by using the training data.

In an implementation, the response module 706 may be used by the virtual agent server 700 to generate one or more different responses to be shared with the user in different scenarios. A user may initiate a response to an advertisement which in turn may require a response from the virtual agent server 700 to the user.

In an implementation, the response module 706 may receive inputs from the NLU module 702 comprising the user's conversation and the context of the user's conversation. Further, the response module 706 may identify one or more recent dialogues in the current conversation that require a response from the virtual agent server 700 to the user. The response module 706 may retrieve one or more parent nodes to identify a parent node which is most suitable to the recent dialogue in the current conversation between the user and the virtual agent server 700. Subsequently, the response module 706 may retrieve one or more child nodes corresponding to the identified parent node. Further, the identified child nodes may be communicated to the user during the conversation.

In an implementation, the response module 706 may build a bipartite graph with a hierarchy of dialogues to converse with the user. The dialogues may be connected and branched away in case one or more new combinations arise during conversations across different communication platforms. The graph may be built on an inverted index data structure to support efficient text search.

In an implementation, as an example, an initiation sentence from the virtual agent server 700 such as “Hello, {Customer Name}! This is {Company}. How can I help you?” may be represented as the root node of a graph. The data in the node may comprise one or more placeholders for one or more of the user's name, and the business name, among others. The placeholders in the conversation for building the graph may be identified by looking for fuzzy string matches from the input dictionary comprising one or more inputs such as the business name, the customer name and the items served by the business, among others.

In yet another implementation, one or more Name Entity recognition techniques may be used to identify the labels in the input.

In an implementation, a node may be annotated with information regarding whether the user or the virtual agent server 700 was the speaker of the dialogue corresponding to that node. The node may also comprise one or more features such as semantic mappings of the sentence and vector computed using sentence2vec algorithm by training a Recurrent neural network on the domain that the software agent is trained for.

In an implementation, a different semantic response from the user may be used to create a child node for the parent node corresponding to the dialogue shared by the virtual agent server 700. The semantic equivalence to the existing nodes on the graph is achieved. In an implementation, the semantic equivalence of two nodes may be calculated by computing cosine similarity between the top results from one or more learn-to-rank algorithms, including, for example, Lambda Mart, borrowed from one or more search techniques after doing a first pass inexpensive ranking on the inverted index of the graph of conversation.

In an implementation, the result from a learn-to-rank algorithm with the highest score exceeding a certain threshold may be used as a representative for the user input. The semantic equivalence comparison and scoring may be done after tokenizing, stemming, normalizing and parametrizing (recognizing placeholders) the input query. Further, one or more slot filling algorithms may be used to parametrize the user responses. The slot filling algorithms may use HMM/CRF models to identify one or more part of speech tags associated with keywords and statistical methods to identify one or more relationships between words. In case there is a match to an existing dialogue from the user, the response module 706 may store the dialogue context of the existing dialogue instead of creating a new node. In case there is no match, a new node may be added to the node of the last conversation.

In an implementation, some dialogues may be questions with straightforward answers. As an example, consider a user asking a question to a virtual agent server 700 representing a restaurant.
User: “What is your specialty?”.
Virtual agent server 700: “Our specialty is Spicy Chicken Pad Kee Mow”.

In another implementation, a user may converse with a virtual agent server representing a shopping website.
User: “Is anything on sale?”
Virtual agent server 700: “Yes, there is a sale of 20% off on all electronic gadgets.”

These dialogues may be indexed on the graph as orphan parent-child relationships in the graph.

In an implementation, a change in context may be a common challenge while building a graph that may constantly learn. In case there is no change in the context, a node may be created as a child of the previous node. In case there is a change in the context, a new node may be needed which is different from the previous state in the graph. In an implementation, one or more classifiers such as a Bayesian or SVM Machine Learning classifier may be used to determine a change in context when the user talks to the customer service representative. The classifier may be trained on crowd sourced training data using one or more features. These features may include one or more of: number of tokens common to a current and previous task; and matching score percentage between the user's speech and the maximum score match of an existing dialogue. A different classifier may be trained for different domains to improve the accuracy of the classifier.

In an implementation, Neural Networks may be used by the virtual agent server 700 to implement personalisation in the conversation with the user. The virtual agent server 700 may be provided with training data comprising one or more stored conversations between two humans. Subsequently, one or more cluster algorithms identified online may be used to train one or more models with the training data received by the virtual agent server 700. Subsequently, one or more user features may be included in the model to accomplish personalization while conversing with the user.

In an implementation, one or more user profiles may be clustered into one or more macro groups to implement personalization to models in a recurrent neural network. An unsupervised clustering algorithm such as K-Means clustering may be used to accomplish this. Alternatively, manually curated clusters may be created based on one or more information about the user such as age group, location and gender of the user, among others. Further, the weight of the examples that had a positive conversion from the virtual agent server 700 may be boosted. In an implementation, this may be achieved by duplicating positive inputs in the training data. The positive inputs may be characterized by one or more pieces of information including the order price and satisfaction from the user, among others. Additionally, one or more user features such as age and gender can be added as an additional input for the Machine Learning models.

In an implementation, the idea of personalization in neural networks may not be specific to conversational customer interactions and may be used in one or more situations including building models which send automatic responses to emails. In an implementation, the graph on the inverted index may be used by a virtual agent server 700 to answer questions about the business. The virtual agent server 700 may start from the root node of the graph to greet the user during a conversation on one or more of a call, SMS or messenger. The user may respond to the greeting with a question about the business. Subsequently, the response module 706 may search for the closest match to the user's question by using techniques borrowed from information retrieval. In an implementation, this may be accomplished using an inverted index to look up possible matches for the user input using an in-expensive algorithm initially and then evaluating the matches with an expensive algorithm such as a Gradient Boosted Decision Tree. The response module 706 may run one or more stemming, tokenization and normalization algorithm on the input query to make sure that the input may be searched properly by the algorithms looking for match before hitting the inverted index.

In an implementation, the advertisement module 708 may be used by the virtual agent server 700 to identify one or more advertisements that the user may be interested in. Further, the advertisement module 708 may be used to communicate the identified advertisements with the user.

In an implementation, the advertisement module 708 may analyze user actions online and offline by collecting their search and browse actions on one or more websites such as FACEBOOK and GOOGLE, among other websites and web applications. Further, the advertisement module 708 may receive offline records from credit transactions.

In an implementation, an identifier for the user may include an email-id, username or a common identifier. This identifier may be used to aggregate information corresponding to one or more actions made by the user. The advertisement module 708 may use one or more big data technologies such as HADOOP, Map-reduce paradigm and one or more real time offline processing frameworks such as Apache KAFKA or Spark to aggregate information. For example, in an implementation, information corresponding to one or user actions may be transferred using Apache KAFKA, stored on HADOOP file system and Map-reduce paradigm may be used to aggregate the data points for a user.

In an implementation, search queries and websites used by the user may be analyzed to derive items the user is interested in. Additionally, advertisements may be customized before communicating the advertisement to the user. One or more placeholders present in the advertisement may be customized to include the user's information at run-time.

In an implementation, the aggregated actions of the user may be used to identify which stage the user is currently in, compared to the advertiser's objectives. For example, in case the user is browsing web pages of camera review sites by entering broad queries such as “best camera” or “camera reviews”, the virtual agent server 700 may determine that he is in the discovery stage.

In an implementation, the aggregated actions of the user may be obtained from one or more current or previous communication sessions involving the user, wherein the communication session was tracked.

In an implementation, the aggregated actions of the user may be obtained from one or more external sources, wherein the external source comprises one or more web applications used by the user or one or more databases comprising information about the user.

In an implementation, the virtual agent server 700 may provide a service to the user to help with completion of transaction after the user has viewed an advertisement and wishes to place an order. The virtual agent server 700 may share one or more advertisements with the user to monetize the transaction service. One or more advertisers may bid on keywords and user profiles similar to online advertisement platforms including Facebook and google ads.

In an implementation, the advertiser's messages for a natural language conversation may be crafted using manual curation. Taking an example of a retailer, the advertiser may use three stages of a purchase funnel. In the first stage, an interaction designer may model the conversation as a “discovery stage” where multiple choices corresponding to a particular type of product may be shown. In the second stage, individual products that the user may be interested in and information about the individual product may be shared with the user. In the third stage, a call for action can be shared with from the user. This call for action may comprise of an offer corresponding to the product which was communicated to the user in the second stage.

In an implementation, a Support Vector Machine learning classifier may be used to determine the conversation intent and stage in the purchase channel after training it with one or more features such as search keywords, domains and categories of the web pages visited by the user. Further, the conversational marketing may be modelled as a graph on an inverted index as discussed above. Additionally, the virtual agent server 700 may use one or more learn-to-rank algorithms such as Gradient Boosted Decision Tree to identify a match for the user context. Making customer interactions conversational by modelling it as a graph on an inverted index hosted on a machine may make the system work efficiently for millions of businesses.

An example of the three advertisement stages may be as follows:

In the first stage, the user may be searching for a broad type of product. The first stage advertisement may include multiple products with a message “Here are some {items}”, where {items} are the product names derived from the actions of the user. In case the user shows interest in the first stage advertisement, a second stage advertisement showing individual product(s) may be shared with the user, along with a message “See this {specific item} on Amazon”. In case the user shows further interest in the second stage advertisement, a third stage advertisement may be shared with the user which includes offers for the individual products shared in the second stage advertisement. Further, a message may be shared with the user stating: “Two days free shipping on {specific item} for the next 5 hours”.

Additionally, an advertising message may then be generated for the user shopping intent which includes one or more appropriate text, image, audio clip, video clip or hyperlink. The advertisement may be shared with the user when they visit a website or watch a video using one or more of an ad network, ad exchange or directly integrated-into-ad platform such as FACEBOOK and GOOGLE which have high traffic.

In an implementation, the controller module 710 may coordinate between other modules of the virtual agent server 700 to assist users in a customer service. Further, the controller module 710 may comprise instructions regarding the actions to be taken by the virtual agent server 700.

In an implementation, the controller module 710 may need to communicate with one or more different application programming interfaces to gain knowledge regarding external systems. As an example, the virtual agent server 700 may communicate with one external application to get customer information and with another external application to get customer service cases. The current application programming interface based communication has become complex to automate as it requires a developer of the software to create mapping between the user context and external application programming interfaces. Further, an application programming interface may be automated by using semantic understanding of the capabilities of the systems. This may be accomplished by creating a global registry of application programming interfaces, with annotations assigned to the parameters with synonyms of the keys which may make it easier for the consuming services to map the runtime context to the parameters. Alternatively, a universal language and a sequence of exchanges for associating input context to an external application programming interface may be created.

In an implementation, the virtual agent server 700 may be able to communicate one or more relevant advertisements to the user when the user is waiting on the completion of a task. In this case, the controller module 710 may determine whether to communicate an advertisement to the user. This may be done by starting another asynchronous thread/process to initiate the execution of the suggestion on behalf of the user. The virtual agent may use the current thread to deliver an advertisement. Simultaneously, the controller module 710 may communicate a message to the user regarding the execution of the suggestion.

As an example, the virtual agent server 700 may communicate the following message to the user: “I am confirming your order with the customer service of the restaurant OLIVE GARDEN. For your next special order, please consider “CALIFORNIA PIZZA KITCHEN”. They have introduced a new dish called Vegetarian Lasagne which you might like”. This communication may be an audio, video or a text advertisement.

As another example, in a retail store context, the customer may place an order. Further, the virtual agent server 700 may communicate the following message to the user: “I am confirming your order with Amazon. For your next purchase, please consider “Buyer's Best Electronics goods.”. They are offering a discount on BLUETOOTH speakers which you may like”.

In an implementation, the advertisement module 708 displays the advertiser's advertisement as follows: the advertisement module 708 may search through the advertiser database and load information corresponding to ads. Further, the advertisement module 708 may assign rank to the advertisements related to one or more of: revenue, preferences of the users, relevance to the user's desired action and to the context of the desired action. Subsequently, the advertisement module 708 may then communicate the advertisement to the user. In an embodiment, a learn to rank algorithm may be used to rank the search results.

In an implementation, FIG. 8 depicts a system 800 comprising a virtual agent server 700 which may represent a web application 806 of a business. The virtual agent server 700 may communicate with a user through their user's mobile device 802 and using a short message service channel 804, a phone call channel or a social network 808.

In an implementation, the system 800 may track a conversation between the user and a web application 806. Further, the virtual agent server 700 may communicate an advertisement directed at the user as part of the conversation between the user and the web application 806. The virtual agent server 700 may receive one or more responses from the user and identify the response is for the advertisement. Further, the virtual agent server 700 may carry out at least one action if the user responded to the advertisement.

In an implementation, the user's mobile device 802 may include mobile phones, palmtops, PDAs, tablet PCs, notebook PCs, laptops and computers, among other computing devices. In an embodiment, the user's mobile device 802 may include any electronic device equipped with a browser to communicate with the virtual agent server 700. The user's mobile device 802 may belong to a user who may use it to communicate with the virtual agent server 700. In an implementation, the user's mobile device 802 communicate with the virtual agent server 700 and share inputs related to the user with the virtual agent server 700.

In an implementation, the virtual agent server 700 may be implemented in the form of one or more processors with a memory coupled to the one or more processors with one or more communication interfaces. The virtual agent server 700 may communicate with one or more external sources and one or more users' mobile devices 802 through a short message service channel. It may be noted that some of the functionality of the virtual agent server 700 may be implemented in the user's mobile device 802.

The system 800 may enable a computing system to converse with a human, wherein the system comprises a plurality of nodes. In an implementation, a first set of nodes may represent statements that may be made by a human, and a second set of nodes may represent statements that may be made by the computing system. The first set of nodes and the second set of nodes may be interconnected such that the interconnection enables the system 800 to select at least one of the statements represented by the second set of nodes, based on a statement from the human, which is mapped to one of the statements represented by first set of nodes.

In an implementation, at least one of the first set of nodes may be directly connected to a plurality of second set of nodes.

In an implementation, the system may be configured to select one or more among the second set of nodes, as a response to a statement represented by one of the first set of nodes to which the second set of nodes is directly connected. The second set of nodes may be selected based on a path navigated to reach the first set of nodes to which the second set of nodes is directly connected.

In an implementation, the system may be configured to enable a customer service representative to converse with the human in case a statement made by the human is not mapped to any of the first set of nodes.

In an implementation, the system may be configured to enable a customer representative to converse with the human in case a statement made by the human is mapped to one of the first set of nodes, which is not connected to any of the second set of nodes at a lower hierarchy.

In an implementation, the system may be configured to generate the first set of nodes and the second set of nodes by processing one or more learning data. In an implementation, the learning data may comprise conversation data between a first category of humans and a second category of humans. Further, the system 800 may be configured to build the interconnection by processing the learning data.

In an implementation, FIG. 9 depicts a flowchart of an exemplary method 900 for interactive advertisement with a user, in accordance with an embodiment. In an implementation, the virtual agent server 700 may receive one or more sets of training data as shown at step 902. The training data may be processed as discussed above. Subsequently, the virtual agent server 700 may learn how to build a conversation by using the training data. Further, one or more parent nodes and their corresponding child nodes may be stored in a database as shown at step 904. The parent node may represent a dialogue and the child node may represent the response dialogue corresponding to the dialogue stored in the parent node.

In an implementation, the virtual agent server 700 may communicate one or more advertisements to the user. In case the user shows an interest, they may respond to the advertisement. The inputs may be received by the virtual agent server 700 as shown at step 906. Further, the virtual agent server 700 may understand the speech of the user by converting it into text and determining a context of the conversation with the user. Further, the virtual agent server 700 may try to determine one or more dialogues that may be similar to the stored parent nodes as shown at step 908. Subsequently, the virtual agent server 700 may retrieve one or more child nodes corresponding to the determined parent node as shown at step 910. In case the virtual agent server 700 has determined that there were no stored child nodes, building further conversation with the user may not be possible. Hence, at step 912, the virtual agent server 700 may connect the user to a human being. This human may be a company representative or a customer service representative, among others. The conversation between the user and the human may be processed by the virtual agent server 700 for processing and learning. Further, the conversation may be added to the training data as shown at step 914.

In case the virtual agent server 700 has determined the presence of a stored child node, it may be retrieved and the dialogue corresponding to that node may be communicated from the virtual agent server 700 to the user.

In an implementation, FIG. 10 depicts a flowchart of an exemplary method 1000 for communicating advertisements to a user, in accordance with an embodiment. As depicted at step 1002, the virtual agent server 700 may receive one or more aggregated actions of the user from one or more sources. Subsequently, the virtual agent server 700 may determine user intent based on the received aggregated actions of the user. Further, the virtual agent server 700 may communicate with one or more databases comprising advertisements to identify one or more advertisements that may be relevant to the user's intent as shown at step 1004.

At step 1006, the first stage advertisement may be communicated to the user. Further, at step 1008, the virtual agent server 700 may determine whether the user responded to the first stage advertisement. In case the user didn't, the virtual agent server 700 may determine not to proceed to communicate a second stage advertisement to the user as shown in step 1010.

In case the user did respond to the first stage advertisement, the virtual agent server 700 may determine to communicate the second stage advertisement to the user as shown at step 1012.

Further, at step 1014, the virtual agent server 700 may determine whether the user has responded to the second stage advertisement. In case the user didn't, the virtual agent server 700 may determine not to proceed to communicate the third stage advertisement to the user as shown at step 1016.

In case the user did respond to the second stage advertisement, the virtual agent server 700 may determine to communicate a third stage advertisement to the user as shown at step 1018.

In an implementation, the exemplary method 900 as described above may be used by a virtual agent server 700 in a customer service context. The virtual agent server 700 may use method 900 to act as a customer service representative and hold conversations with a user.

In an implementation, the user may be browsing online on one or more websites. Further, the user may be shown an advertisement, which may need to be encoded with information about the user to make the advertisement actionable for an organization. Further, the identity of the user may be encrypted to protect the user's privacy. Such encryption may be accomplished by using one or more methods such as one way hashes or public private key encryption mechanisms.

In an implementation, the virtual agent server 700 may identify the user by looking up one or more stored mapping information in one or more encrypted mapping between the user and the encrypted id in case the user starts to interact with the advertisement generated by the virtual agent server 700 on the social networks 810 and other external applications. The interaction with the user may be then personalized and one or more actions may be triggered for that advertisement.

In an implementation, the user information may include one or more of email-id, phone number, first name and last name combination. Further, the user information may be matched with similar identifiers on one or more social networks 810 and other external applications, among others. One or more user information may be exchanged with the social networks 810 and other external applications to make sure that the privacy of the user is protected. This may be achieved by using encrypted identifiers constructed from one or more user information.

In an implementation, the advertisement may be one or more of an actionable display, conversation or a bot advertisement, wherein the user may start interacting with the virtual agent server 700.

FIG. 11 depicts a flow diagram of an exemplary method 1100 for communicating advertisements to a user through actionable marketing, in accordance with an embodiment. As an example, Voicemonk advertisement server may provide a conversational advertisement service to an Italian Restaurant “OLIVE GARDEN”. The Voicemonk advertisement server may communicate with a website being browsed by the user, an advertisement campaign manager and an OLIVE GARDEN Point of Sale (POS) server as shown in the figure.

In an implementation, a user “Tom” may be a regular customer of OLIVE GARDEN, who has not visited the restaurant recently. The Voicemonk advertisement server may be responsible for engaging Tom to make him visit the restaurant. The Voicemonk advertisement server may display an actionable advertisement by using one or more user information related to “Tom” to accomplish this. Hence, the Voicemonk advertisement server may communicate with the advertisement campaign manager regarding an advertisement which may include a 20% discount for loyal customers, as shown at step 1102. Further, the Voicemonk advertisement server may communicate with the OLIVE GARDEN POS server regarding information details of loyal customers, as shown at step 1104.

Further, in an implementation, the Voicemonk advertisement server may locate Tom and match the id information of loyal customer Tom as shown at step 1106. Subsequently, the Voicemonk advertisement server may display an advertisement to Tom through the website or application that is being used by Tom. The advertisement may include a 20% off link only valid for Tom, as shown in the website at step 1108: “It has been a while since you last came to OLIVE GARDEN. We are offering a 20% discount for today's special, ‘Italian Lasagna’ to loyal customers like you. Please click on this ad to accept the offer and place an order.”

In an implementation, Tom may click on the order as shown at step 1110. Further, as shown at step 1112, the Voicemonk advertisement server may be able to identify the user using the method described above. Subsequently, the virtual agent server 700 may communicate Tom's order at the OLIVE GARDEN POS server, as shown at step 1114. Further, the Voicemonk advertisement server may communicate with Tom in a personalised natural language conversation as shown at step 1116. The conversation may include calling up the restaurant, making reservations, clearing one or more doubts related to an order, and placing an order at the restaurant by calling the external Point of Sale Application Programming Interface, among others.

FIG. 12 illustrates an exemplary architecture of a system 1200 for generating search tokens for a user, in accordance with an embodiment. The system 1200 includes a server 1204 that communicates with one or more users using their data processing devices 1202 a-c. User A may operate their device 1202 a, namely, their mobile phone; user B may operate their device 1202 b which is a desktop computer and user C may operate their device 1202 c which is a laptop.

The device 1202 (also referred to as a device of the user) may include mobile phones, palmtops, PDAs, tablet PCs, notebook PCs, laptops and computers, among other computing devices. In an embodiment, the device 1202 may include any electronic device equipped with a browser to communicate with the server 1204. The device 1202 may be used by the user to communicate with other users. The device 1202 may also include one or more input and output components such as a microphone, keypad, speaker and display, among others.

The server 1204 may be implemented in the form of one or more processors with a memory coupled to the one or more processors. The server 1204 may be implemented as appropriate in hardware, computer-executable instructions, firmware, or combinations thereof. Computer-executable instructions or firmware implementations of the server 1204 may include computer-executable or machine-executable instructions written in any suitable programming language to perform the various functions described. Further, the server 1204 may communicate with one or more external sources and one or more user's devices 1202 through the communication module 1302.

FIG. 13 illustrates an exemplary block diagram 1300 of a server 1204, in accordance with an embodiment.

In an embodiment, the server 1204 comprises a communication module 1302, a security module 1304, a token generation module 1306 and a memory module 1308.

In an embodiment, the communication module 1302 may provide an interface between the server 1204 and one or more users' devices 1202 a-c. The communication module 1302 may support both wired and wireless protocols. Data in the form of electronic, electromagnetic, optical signals and other signals may be transferred via the communication module 1302. Further, the communication module 1302 may be present for different technologies including WLAN, LTE and GPS, among others.

In an embodiment, the security module 1304 may be configured to implement one or more security protocols and/or applications in order to protect one or more data stored or transmitted by the system 1200.

In an embodiment, the token generation module 1306 may be configured to include one or more modules that may be responsible for generating one or more search tokens related to the user.

In an embodiment, the memory module 1308 may be implemented in the form of a primary and a secondary memory. The memory module 1308 may store additional data and program instructions that are loadable and executable on the server 1204, as well as data generated during the execution of these programs. Further, the memory module 1308 may be volatile memory, such as random-access memory and/or a disk drive, or non-volatile memory. The memory module 1304 may further include one or more removable memory such as a Compact Flash card, Memory Stick, Smart Media, Multimedia Card, Secure Digital memory, databases or any other memory storage that exists currently or may exist in the future.

FIG. 14 illustrates an exemplary block diagram 1400 of a token generation module 1306 for the system 1200, in accordance with an embodiment. The token generation module 1306 includes a retrieval module 1402, a search queries database 1404, a ranking module 1406, a model database 1408, aggregated logs 1410 and a learning module 1412.

In an embodiment, the retrieval module 1402 may be configured to implement one or more machine-learning models and/or human-defined rules. The retrieval module 1402 may determine a list of search queries after processing one or more inputs including data related to the user and user behavior profile. The retrieval module 1402 may communicate the retrieved search queries to one or more modules present in the system 1200.

In an embodiment, the search queries database 1404 may comprise one or more search queries related to one or more topics that the user may be interested in. The retrieval module 1402 may communicate one or more search queries related to one or more topics to the ranking module 1406.

In an embodiment, the ranking module 1406 may be a module comprising a deep feed forward neural network, used to rank one or more search queries according to the probability of being used/popular with the user. The deep feed forward neural network may compute a “tan [h]” score on one or more input features in order to rank the items.

In an embodiment, one or more input features for the ranking module 1406 may comprise one or more of word embeddings of search tokens, aggregated behavior, location of the user or demographic information of the user.

In an embodiment, when a user conducts online activity, one or more search queries in the form of one or more search tokens may be generated. The user's actions, queries and impressions may be recorded into the aggregated logs 1410 as training data for the learning module 1412.

In an embodiment, the learning module 1412 may comprise one or more machine learning and/or artificial intelligence methods that may be trained with one or more input data to achieve a certain task. The input data may include one or more of user actions, search queries or user impressions, which may be communicated as training data to the learning module 1412.

FIG. 15 illustrates an exemplary block diagram 1500 for a behavior-to-search model for the system 1200, in accordance with an embodiment. This figure depicts the inputs and outputs of the various stages in the generation of search tokens for a user.

In an embodiment, the behavior-to-search algorithm depicted in FIG. 15 may comprise two Recurrent Neural Networks (RNN). The first RNN may comprise an encoder that may process the input data. The second RNN may comprise a decoder that may generate the output search tokens. The behavior-to-search model may predict one or more follow up queries that the users may type onto a search engine after experiencing one or more events.

In an embodiment, the behavior-to-search algorithm may receive training data for the aggregated user behavior and search query from multiple applications as follows. The input may include one or more data from a digital social platform viewed by the user, as depicted in step 1502. The input may include an advertisement feed that was viewed by the user as depicted in step 1504. The input may include meeting information and geographical information related to one or more offline events attended by the user, as depicted in step 1506. Another input may include one or more websites, items, services and brands that the user viewed while shopping online, as depicted at step 1508. Another input may include one or more online queries entered by the user into a search engine, and the subsequent websites, articles and information viewed by the user, as depicted at step 1510. Further, a ‘go’ signal may be entered as an input in order to initiate the generation of the search tokens, as depicted at step 1512. Thus, the RNN may generate the first search token, ‘search query 1’, as depicted at step 1514 and a second search token ‘search query 2’, as shown in step 1518. It is to be noted that the behavior-to-search model may generate more than two search tokens, according to the inputs and computation of the model. The time series TN−1 may be entered as shown at step 1516 and TN may be entered as shown at step 1520. The signal ‘EOS’ may depict the end of the output computation, as shown at step 1522.

FIG. 16 illustrates an exemplary block diagram 1600 for a wide and deep neural network for the system 1200, in accordance with an embodiment. One or more training data may be entered as an input into one or more wide and deep neural networks to gather and rank web search queries. The wide and deep neural network may be used to focus on one or more different information elements to generate the search tokens. Further, the wide and deep neural network may be used for the accumulation and ranking of one or more search queries determined by the behavior-to-search neural network model.

In an embodiment, the input data for FIG. 16 may comprise one or more data related to the user including one or more of age 1612, social network 1614 used by the user, visual images 1616 viewed by the user, offline location data 1618 of the user, meeting information 1620 of the user, user demographic information 1622, or past search engine query 1624. The embeddings 1610 vector of one or more of these input data may be determined and subsequently concatenated with one or more of the other features available to the system 1200, to create concatenated embeddings 1606. The embeddings may then be communicated to one or more Rectified linear units (ReLU) 1604 layers, which is similar to a ramp function. The output of the Rectified linear units (ReLU) 1604 may be trained to optimize the logistic loss on predicting embeddings for one or more search tokens.

FIG. 18 illustrates an exemplary flow diagram 1800 depicting a method for generating a hyper-personalized marketing message for the system 1200, in accordance with an embodiment.

In an embodiment, according to step 1802, the system 1200 may feed one or more inputs into a learning module to determine one or more item(s), optimum discount(s) for the item(s) and optimum time to recommend the item(s) to the user. Further, the system 1200 may recommend the determined items and discounts to the user at the optimum time, as shown at step 1804. The system 1200 may then determine whether the user is interested in the items, as shown at step 1806. In case the user is not interested in the recommended items, the system 1200 may proceed to step 1802 to determine one or more other items that the user may be interested in. Further, in case the user was interested in the item, the system 1200 may communicate with one or more external systems to place an order for the items on behalf of the user, as shown at step 1808.

In an embodiment, the system 1200 may collect one or more user data to build a user profile vector using which, customized search tokens can be generated for a particular user. The search tokens may comprise items or topics of interest to the user. Thus, the search tokens may be used for a number of applications such as a) generating content articles for a user; and b) advertisement monetization.

### Data Enrichment for Deep Learning Algorithms

FIG. 17 illustrates an exemplary flow diagram 1700 depicting a method for generating aggregated user behavior using the system 1200, in accordance with an embodiment.

In an embodiment, a q-table may be built for the expected values of one or more actions for a given situation, as shown at step 1702. Further, the system 1200 may receive one or more inputs from the user vector and centroid vector of the user cluster using one or more aggregated profiles, as shown in step 1704. The system 1200 may then use the computed aggregated vectors to compute similar users, and use actions from one or more similar users to build the values of the q-table for the user, as shown at step 1706. Subsequently, the system 1200 may hash one or more use profiles into one or more buckets, as shown at step 1708.

In an embodiment, for some users, there may be a lack of historic data at a user level which is required to determine the expected value of an advertisement/content article to the user. In this case, data derived from interactions between similar users and generated ads may be used for generating search tokens for the user. Thus, the system 1200 may determine an aggregated user profile from multiple online and offline sources and further use the aggregated user profile to generate search tokens for a similar user.

In an embodiment, one or more of an aggregated profile vector, previous purchase data or one or more item vectors may be fed into a Deep Reinforcement Learning algorithm to determine one or more items that may be of interest to the user. These items may be recommended to the user in a hyper personalized marketing message.

In an embodiment, an end-to-end training algorithm such as Deep Reinforcement Learning/Deep Neural Net Supervised algorithm may be used to predict one or more features including timing of the advertisement, recommended item or user segment for the actionable marketing message described above.

In an embodiment, one or more recommendation algorithms including Collaborative Filtering algorithm leveraging one or more of previous clicks, order transactions or aggregated user behavior profiles may be used to determine similar item recommendations for the user.

In an embodiment, the Deep Reinforcement algorithm may build a value table or a q-table for the expected values of actions at a given state and previous actions/interactions between the user and the content articles. To build the value table or the q-table, data may not be available for each user. In this case, the aggregated vector may be to be computed for one or more similar users. Subsequently, one or more actions from similar users crossing a certain similarity threshold may be used to build the values of the q-table for the user.

In an embodiment, the aggregated user profile vector may be used in one or more collaborative filtering algorithms as an additional variable to generate one or more recommendations and content articles for the user.

In an embodiment, the recommendations may include one or more of similar items or other recommendations on the websites seen by the user.

### Generating Search Tokens

In an embodiment, as an example, user A may use their mobile phone 1202 a, user B may use their desktop computer 1202 b and user C may use their laptop 1202 c as depicted in FIG. 12. The server 1204 may comprise one or more processors operable to receive and store one or more user information related to one or more users in a user database. One or more external data may be received from one or more external sources such as e-commerce websites, social media networks or databases, among others. Further, the server 1204 may identify one or more profiles and/or accounts of the user on one or more digital platforms. The server 1204 may then collect and store one or more information related to one or more activities of the user on the digital platforms and in external systems, in the user database. Subsequently, the server 1204 may build a user profile vector to characterize the user's behavior. Further, the server 1204 may process the user profile vector with the help of a learning module 1412 in order to derive one or more search tokens and rank the search tokens to identify one or more content that is of interest to the user.

As an example, the user may have looked at one or more pictures of chocolate cakes on a digital social platform. The server 1204 may identify and/or verify the user's profile and/or virtual account(s) using one or more stored or external data to confirm the identity of the user. Further, the server 1204 may collect and store information related to the images viewed by the user on the digital social platform. The server 1204 may then use the learning module 1412 to build a user profile vector to derive one or more search tokens. Further, the server 1204 may rank the search tokens to identify one or more content that is of interest to the user. The topmost results in the search tokens may include content related to chocolate cake such as “Best chocolate cake”, “Buy chocolate cakes online now” and “Get chocolate cake delivered to your doorstep”, among others. The server 1204 may contact one or more external systems that are related to the content. Thereafter, the server 1204 may suggest or recommend chocolate cakes to the user by displaying one or more images or videos of a chocolate cake from a particular chocolate cake company called “Cake Zone” to the user. Further, the server 1204 may communicate one or more of advertisement, notice, a suggestion or an actionable recommendation to the user. Thus, the user may follow up on the content of the search tokens generated by the learning module 1412 of the server 1204.

In an embodiment, the system 1200, in particular, the server 1204 may build the user's user profile vector by processing word tokens derived from one or more of a social network, previous search engine queries, offline location data, meeting information, user demographic information, vectors for the images that the user sees, or the time associated with each event, among others. The word tokens may comprise words or phrases related to the content viewed by the user.

In an embodiment, the user profile vector may be used to train one or more learning modules to generate one or more search tokens. The search tokens may comprise words/phrases that are predicted to be of interest to the user.

In an embodiment, the server 1204 may generate the search tokens using Machine Learning (ML) algorithms and rule-based algorithms. As an example, in an embodiment an inverted index may be built, comprising search queries annotated with broad level categories from one or more users. A Latent Dirichlet allocation (LDA) algorithm and/or manually annotated rules may be used to construct one or more broad level categories from the aggregated user behavior. These broad level categories may then be used to gather all the possible search queries, which may be communicated to other modules as search tokens.

In an embodiment, the retrieval module 1402 may communicate the retrieved search queries to the ranking module 1406, which may use one or more ranking methods to rank the search queries. Further, the ranking module 1406 may rank the search queries according to their scores.

The recommendation algorithm may comprise a two-step process. In the first step, possible search tokens may be generated. In the second step, the search tokens may be ranked and the top ‘n’ selected search tokens may be recommended to the user. The search queries relate to possible queries that the user may browse online.

In an embodiment, the generation of search tokens may be implemented in three stages. In the first stage, one or more input data related to the user may be gathered. Further, in the second step, the ranking module 1406 may use one or more generic or inexpensive ranking functions to rank the results. Optionally, in the third step, the ranking module 306 may use a more specific or expensive ranking system for the same.

In an embodiment, the server 1204 may process the search token(s) using one or more ranking modules 1406 and rank them according to their effectiveness on the user.

In an embodiment, the search tokens may be derived using a behavior-to-search algorithm including one or more of attention mechanism or external memory.

In an embodiment, the attention mechanism may be used to focus on salient data parts, such as focusing on a single part of the provided data subset at a time. It may also be used as an approach for memory addressing. A conventional sequence-to-sequence model may reduce its input into a single vector and then expand it to generate the output. However, the system 1200 may enhance this method by using the attention mechanism. The attention mechanism may allow the input-processing encoder module to pass along information regarding each data it may process. Further, the attention mechanism may allow the output-generating decoder module to focus on any relevant data.

In an embodiment, using memory mechanism may provide data storage over a period of time.

In an embodiment, each box in FIG. 15 may represent an RNN cell with an attention mechanism capable of retaining memory, such as, for example, a gated recurrent unit (GRU) or a long short-term memory (LSTM) cell. The encoder and the decoder may share weights or use different sets of parameters. Every input transmitted into the RNN cells may be encoded into a fixed-size state vector which may be passed on to the decoder.

In an embodiment, the LSTM cell may include one or more cells that each include an input gate, a forget gate, and an output gate that may allow the cell to store previous states for the cell. This LSTM cell may be used in generating a current output or it may be provided to other components of the LSTM neural network.

In an embodiment, as an example, the encoder cells may use the user behavior profile as an input sequence. Further, the encoder cells may process and output one or more titles of newly crawled data as a concatenation of word vectors (through an average of word vectors) to predict one or more information search queries. The decoder cell may produce one or more search tokens as long as the <EOS> (end of signal) token is not created. Once the <EOS> signal is created, the system may stop the generation of search queries.

In an embodiment, the encoder and decoder LSTM cells may use Gradient Descent Backpropagation to optimize the cross-entropy loss while determining the probability to predict the next token in the sequence. Further, one or more training data comprising aggregated user behavior data may be presented in a time series sequence and Information Search queries, which may be fed to the encoder and decoder LSTM cells.

In an embodiment, as an example, one or more training data comprising of aggregated user behavior data and Navigation Search queries may be fed to the encoder LSTM cell(s). The encoder LSTM cell(s) may use the attention mechanism on the encoded vector of the input sequence comprising behavior data and newly crawled popular data to predict one or more queries such as stock price of PCLN. The attention vector and weights for the LSTM cell(s) may be trained using Gradient Descent Backpropagation to minimize the cross entropy and predict search tokens.

In an embodiment, as an example, one or more input features may be entered into the LSTM cell(s). The input features may comprise one or more of word embeddings of search tokens, aggregated user behavior, user features such as location of the user or one or more demographic information of the user to rank the results. The output of the RNNs may be given as an input to the ranking module 306.

In an embodiment, the behavior-to-search model of FIG. 15 may receive inputs using a time series data. Further, the inputs may include one or more word-tokens of the user's aggregated user behavior. These word tokens may be derived from one or more sources such as digital social platforms, previous search engine queries, offline location data, meeting information, user demographic information and vectors for the images seen by the user. Furthermore, the time associated with each of the events may be the time-series input source for the behavior-to-search model.

In an embodiment, consider the following example inputs for the behavior-to-search model.

Behavior Input in the last 5 hours:
a) Social Feed—user saw a notification of Sam's upcoming 30th birthday, user liked Nicki's video on New Zealand, user commented on pictures of Jane's Lake Tahoe vacation pictures, among others.
b) Advertisement feed—user read reviews in the advertisement of a book ‘Mathematics of Stock Market’ and user has clicked on an advertisement for ‘Unique Birthday gifts’.
c) Offline Events—user went to an Artificial Intelligence meeting in San Francisco, user met his previous co-worker Christa at Starbucks in Palo Alto and user ate lunch at Olive Garden.
d) Online shopping—user shops online for ‘home swing set’, user browses different brands of cheese, user chooses a home service for picking up laundry on a website.
e) Online queries—user has used his VR gear to explore Grand Canyon and user searched for Bay Area home prices and PCLN stock <EOS>.

In an embodiment, the output may comprise the generated search tokens of the behavior-to-search model. As an example, the output may be: Actual Search queries in the next hour: AI Frontiers Conference, Birthday gifts for a 30-year-old, buy cheese online and vacations in New Zealand.

In an embodiment, in addition to the behavior vector, the titles/summary of newly crawled popular data from one or more search engines may be communicated as an input to the behavior-to-search model.

In an embodiment, the wide component of the figure comprises a linear model while the deep component may comprise a feed-forward neural network. The inputs may be in the form of strings, which are converted into a vector called embedding vector. One or more of these embeddings are initialized and trained to minimize a final loss function related to the training of the model. The deep component and the wide component may be combined using one or more weighted sums.

In an embodiment, one or more search queries may be entered as an input into a wide and deep neural network for the search queries trained to optimize logistic loss on predicting embeddings for search tokens. As an example, a network with memorization using Wide Neural Network may be used to predict one or more navigation search queries derived from cross training data. The training data may comprise one or more behavior patterns and search queries. The training data itself may be expressed as AND [pcln search query=1, pcln search query] based on one or more past interactions of aggregated user behavior and the search queries. The deep neural network may use the embedding of the same aggregated user behavior and rank the informational search queries.

In an embodiment, a method for generating search tokens for a user may be provided. The method may comprise receiving and storing one or more user information in a user database. Further, the method may comprise identifying one or more profiles and accounts of the user on one or more digital platforms. The method may then comprise collecting and storing one or more information related to one or more activities of the user on the digital platforms and in external systems, in the user database. Subsequently, the method may comprise building a user profile vector to characterize the user's behavior and processing the user profile vector with the help of a learning module in order to derive one or more search tokens. Thereafter, the method may comprise ranking the search tokens to identify one or more content that may be of interest to the user.

In an embodiment, in case the user data related to the user's online profile and/or accounts was insufficient or unavailable, the server 1204 may build a user profile vector based on one or more other users who are similar to the user. This user profile vector or user profile behavior may be called an aggregated user profile. The aggregated user profile may be constructed by aggregating information from one or more websites and offline store actions. The websites may include one or more of social networks, search engines or websites. The activities of a similar user profile may be collected from multiple websites using one-way hashes to protect the privacy of the user. We may build a user profile vector to characterize the user's behavior. In an embodiment, this may be accomplished by summing up word vectors for search tokens aggregated from social feeds, search queries, chat history or information about friends. In another embodiment, the word vectors of tokens of anonymized behavioral data may be concatenated.

In an embodiment, while evaluating similarity between two or more users, their similarity may be computed using cosine similarity between two user vectors along with other variables such as conditional probability distances between the users. This step may also be combined with one or more bucketing techniques to increase the efficiency of the comparison.

In an embodiment, the user profiles may be hashed into one or more buckets using mechanisms such as Locality Sensitive Hashing algorithms to make the computation faster and reduce the memory space required for computing user similarity.

In an embodiment, the server 1204 may use one or more recommendation algorithms to predict search tokens and/or search queries based on aggregated user behavior.

In an embodiment, the server 1204 may be further configured to display the content to the user on one or more of the digital platforms used by the user.

In an embodiment, the digital platforms may include one or more of social networks, search engines, chat window, applications or websites.

In an embodiment, the content may include one or more of an advertisement, a notice, a suggestion or an actionable recommendation that capture the interest of the user.

In an embodiment, the system 1200 may determine when the merchant should send an actionable marketing message to the user. As an example, the system 1200 may determine whether the marketing message must be communicated to the customer before lunchtime or dinner time; or after a single day or after seven days of their previous purchase, among others. The timing of the marketing message may have a significant impact on its conversion rate. This problem may be treated as a regression problem in Machine Learning. One or more features such as previous transactions, search history and social media posts may be used to determine the timing of the marketing message for the user. Further, data related to responses from similar users computed using methods described above may also be used.

In an embodiment, another example of actionable content comprises the search query typed by the user into a search box. Search engines such as GOOGLE and MICROSOFT have been able to monetize the search traffic exceptionally well as the search query completely captures the user intent and has high actionable intent.

In an embodiment, a social network such as LINKEDIN may use the system 1200 to predict that one or more e-commerce executives may search for “conversational commerce software”. This may be accomplished by using one or more inputs such as the aggregated user behavior on the social network (in case the executive may be reading articles about conversational commerce), data from visits to the websites of conversational commerce companies, location information and offline meetings, among others.

In an embodiment, the predicted search tokens may be used by one or more search engines such as GOOGLE and MICROSOFT to pre-populate the search query in the search text box and show one or more search results.

In an embodiment, the method described above may be implemented by issuing a query for the predicted interests to a horizontal search engine such as GOOGLE.com and/or BING.com. The predicted interest intents may be derived by training a behavior-to-search neural network with one or more vectors gathered from the aggregated user behavior profile and one or more observed interest intent. Additionally, the deep reinforcement learning algorithm may be used to optimize the intent predictions further by observing the engagement with one or more predicted interests and aggregated user profiles.

In an embodiment, the generation of search tokens can be monetized. One or more applications showing one or more notifications to the user regarding new deals or upcoming meetings may become more efficient and accurate by using one or more aggregated behavior vectors gathered from multiple sources. As a first step, the aggregated behavior of the user may be used to ensure that the notification is a new notification. This may be done by implementing a semantic comparison between the new notification and any notifications that the user has seen in the past. In an embodiment, the semantic comparison may be done by computing the similarity between one or more paragraph vectors of the new event and one or more other events in the aggregated user behavior profile.

In an embodiment, once the system 1200 has confirmed that the notification is a new notification, the system 1200 may concatenate a personal preference (expressed, for example, as a category vector) and one or more demographic group vectors to the notification to ensure that it is a good notification to display to the user. The notification may be scored to evaluate its importance to the user. In an embodiment, this may be implemented by a simple cosine similarity between the user preference vector and the notification vector. The score may be used to show notifications in one more different colors depending upon the predicted engagement. An implicit engagement between the notification and the user aggregated profile may be further optimized by a deep reinforcement learning module to further improve the quality of the notification.

In an embodiment, one or more social networking sites may use the above-described method to personalize notifications displayed to users through their website. The personalization of notifications may be used to monetize one or more services offered or displayed by the social networking website.

### Monetization System for a Service Using Predicted Search Tokens

Once a user has determined their target customer base, the user may derive one or more keywords from the predicted search tokens. Further, using an application such as GOOGLE ADWORDS, the user may place a bid on shortlisted keywords.

In an embodiment, the user may use an application such as GOOGLE ADWORDS to reach new customers and grow their business. The user can become an active advertiser by targeting customers across the search network and the display network. The search network refers to Pay-Per-Click (PPC) advertising, wherein advertisers bid on keywords that may be relevant for their business to have a chance to display their advertisements to customers who enter those keywords into GOOGLE as part of their search query. The display network offers advertisers the option of placing visual banner advertisements on websites that are part of the Display network.

In an embodiment, advertising merchants may use an advertisement campaign management website on a social network and choose one or more predicted search keywords to show one or more advertisements on a social network and/or website.

In an embodiment, it is to be noted, that this is unlike existing advertising systems such as AdWords, wherein advertisers are bidding on search queries that happen on the search engine such as Google.com and Bing.com. As an example, a company selling a conversational commerce software such as VOICY.AI may bid on one or more advertising slots targeting ecommerce executives on social network such as LINKEDIN; wherein the executives are predicted to use a search engine to search for keywords such as “conversational software”, “conversational commerce companies”, “conversational commerce startups” in the next week or month.

In an embodiment, one or more inputs comprising previous purchase history vector, user profile vector, time intervals of aggregated actions, image vectors seen on social network, social feed, search history and AMAZON ALEXA queries, among other data aggregated from one or more search engines may be used to predict the search query of one or more commerce websites including FLIPKART.com, AMAZON.com and EBAY.com, using the system 1200 to generate one or more search tokens for the user.

In an embodiment, the aggregated user behavior profile may also be used to personalize the user's home page on one or more social networks and/or websites, based on the prediction of search/merchandising intent using the above methods. In an embodiment, personalization may be implemented by showing the user one or more items they may be interested in, using one or more predicted search queries.

In an embodiment, the predicted search tokens may be used to show one or more content to users on social networks and/or websites that the users may interact with. The predicted search tokens may also be used to show one or more relevant advertisements. Further, one or more advertisement slots on social networks and/or websites may be populated by auctioning them to one or more advertisers.

In an embodiment, the applications showing one or more notifications to the user regarding new deals or upcoming meetings may become more efficient and accurate by using one or more aggregated behavior vectors gathered from multiple sources. As a first step, the aggregated behavior of the user may be used to ensure that the notification is a new notification. This may be done by implementing a semantic comparison between the new notification and any notifications that the user has seen in the past. In an embodiment, the semantic comparison may be done by computing the similarity between one or more paragraph vectors of the new event and one or more other events in the aggregated user behavior profile.

In an embodiment, once the system 1200 has confirmed that the notification is a new notification, the system 1200 may concatenate a personal preference (expressed, for example, as a category vector) and one or more demographic group vectors to the notification to ensure that it is a good notification to display to the user. The notification may be scored to evaluate its importance to the user. In an embodiment, this may be implemented by a simple cosine similarity between the user preference vector and the notification vector. The score may be used to show notifications in one more different colors depending upon the predicted engagement. An implicit engagement between the notification and the user aggregated profile may be further optimized by a deep reinforcement learning module to further improve the quality of the notification.

### Generating Hyper-Personalized Marketing Messages

In an embodiment, one or more deep learning techniques may also be used to improve actionable advertisements that are specifically targeted at the user. Merchants today are spending on video and display advertising to increase their customer base. Such merchants may make better use of their marketing budget by targeting users with one or more hyper-personalized actionable ad (advertisements which require immediate action from the user) and by targeting users who may have an anticipated need soon.

In an embodiment, the hyper-personalized marketing message may be created by using deep reinforcement learning to compute the expected value of a content article for a given state of user interaction with a website/application/system. Depending on the context of the application, the state in reinforcement learning may be a combination of the user's search history and behavioral interest. The user's behavioral actions may include one or more clicks on a content article, filling a login form and completing a purchase action, among others.

In an embodiment, as an example for a hyper-personalized marketing message, the system 1200 may have collected and fed one or more inputs related to a user into the learning module. The inputs may comprise the user's social network media feed, browsing history and user impressions. Subsequently, the learning module 1412 may determine that the user may be interested in eating food from their favorite restaurant, “Olive Garden”, around noon. Further, the learning module may use past transactions of the user to determine their favorite dish and offer a discount of 20% on it. Consequently, the system 1200 may display one or more advertisements related to “Grilled Chicken Flatbread” around noon to the user through one or more devices 1202 of the user. In case the user does not click on the advertisement to pursue it, the system 1200 may determine that the user is not interested in the offer for that dish. Subsequently, the system 1200 may determine one or more other dishes that the user may be interested in. In case the user clicks on the advertisement, the system 1200 may communicate with the point of sale system of “Olive Garden” using an Application Programming Interface (API) call or through an email which may be communicated to the merchant. The user-id of the user may be encrypted when the marketing message is sent out to ensure the privacy of the user.

In an embodiment, an example of the advertisement communicated to the user may be “You have been a valuable customer of Olive Garden. We are happy to offer you 20% discount on your favorite dish “Grilled Chicken Flatbread” You can click “yes” to place an order.”. Subsequently, the user may click yes in the advertisement. Further, the user may order one or more dishes which will be communicated to the Point of Service system of the restaurant “Olive Garden”.

In an embodiment, the appropriate discount for the user may be determined using a Regression algorithm trained to optimize one or more variables including revenue per marketing message and/or conversion probability on the marketing message. As an example, in an embodiment, the system 100 may determine an appropriate personalized discount for the user to complete a transaction with the merchant. As an example, a user may not be interested in a dish “Chicken Sandwich” at a 10% discount, but may be tempted to order the dish, in case a discount of 20% is offered to the customer.

In an embodiment, the predicted interests of the user may be used to display a personalized data feed on the user's device 1202, after the user unlocks the device 1202. This may decrease the time and effort put in by the user for typing and searching for one or more search queries.

It should be understood, that the capabilities of the invention described in the present disclosure and elements shown in the figures may be implemented in various forms of hardware, firmware, software, recordable medium or combinations thereof.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. A computer-implemented method for usage recall on a user device, the method comprising:
capturing, at intervals, visual content presented on a display of the user device;
analyzing the captured visual content by dividing the content into pixels and processing the pixels with a neural network trained to recognize visual elements and positions of the visual elements to produce an element map;
storing, in a local context store, entries that associate the captured visual content with (i) a time, (ii) an application or window identifier, and (iii) descriptors of the recognized visual elements;
recognizing text in the captured visual content and storing tokens linked with the entry;
receiving a natural-language user query describing a past activity;
retrieving, from the local context store, an entry responsive to the user query using the descriptors and/or tokens; and
re-establishing at least part of a prior application state by programmatically generating user-interface events directed to a target visual element specified from the element map, without invoking application-specific deep links or intents.

2. The method of claim 1, wherein the user-interface events comprise at least one of pointer events, keyboard events, touch events, or accessibility-framework actions.

3. The method of claim 1, wherein the entries are stored and processed on-device.

4. The method of claim 1, wherein recognizing text comprises extracting tokens from the captured visual content using a text analyzer and storing the tokens with the entry to facilitate retrieval by the natural-language user query.

5. The method of claim 1, wherein re-establishing the prior application state comprises targeting the target visual element by its recognized position in the element map.

6. The method of claim 1, wherein the neural network outputs a map of user-interface controls including at least one of: buttons, input fields, menu items, or links.

7. The method of claim 1, further comprising recording a sequence of user actions across multiple applications and, upon retrieval of the entry, replaying a subset of the sequence to re-establish context.

8. The method of claim 1, wherein re-establishing comprises directing the user-interface events to elements exposed by an accessibility surface when available.

9. The method of claim 1, wherein storing comprises indexing each entry by the time, the application or window identifier, and one or more of the descriptors of the recognized visual elements.

10. The method of claim 1, wherein receiving the natural-language user query comprises parsing the query to tokens and matching the tokens to the stored descriptors and/or tokens of the entries.

11. A computer-implemented method for cross-application task execution on a user device, the method comprising:
analyzing visual content currently presented on a display of the user device to identify visual elements and corresponding positions;
analyzing records of a user's prior behavior across applications;
determining an intention of the user for a current task based on the analyzed visual content and the prior behavior;
planning a sequence of actions across one or more applications to accomplish the current task; and
executing, by a universal virtual agent, the sequence by emitting programmatic user-interface events directed to on-screen elements identified from the analysis, using generic operating-system input primitives and without requiring application-specific deep links or intents.

12. The method of claim 11, wherein determining the intention comprises processing the visual content using a neural network and combining outputs with a user profile vector derived from historical activity.

13. The method of claim 11, wherein the universal virtual agent operates using the generic operating-system input primitives without requiring application-specific integrations.

14. The method of claim 11, further comprising responding to a natural-language instruction from the user and grounding the instruction to the identified visual elements to select targets for the user-interface events.

15. The method of claim 11, wherein planning includes assigning weights to preferences of multiple participants and selecting actions that optimize a group objective.

16. The method of claim 11, wherein the universal virtual agent performs a follow-on action in a second application in response to an action taken by the user in a first application.

17. The method of claim 11, wherein executing comprises directing the user-interface events to elements identified from the element map or, when available, from an accessibility surface.

18. A non-transitory computer-readable medium storing instructions that, when executed by one or more processors of a user device, cause the one or more processors to perform operations comprising:
capturing, at intervals, visual content presented on a display of the user device;
analyzing the captured visual content by dividing the content into pixels and processing the pixels with a neural network trained to recognize visual elements and positions of the visual elements to produce an element map;
storing, in a local context store, entries that associate the captured visual content with (i) a time, (ii) an application or window identifier, and (iii) descriptors of the recognized visual elements;
receiving a natural-language query describing a past activity;
retrieving, from the local context store, an entry responsive to the query; and
re-establishing at least part of a prior application state by programmatically generating user-interface events directed to a target visual element specified from the element map, without invoking application-specific deep links or intents.

19. The non-transitory computer-readable medium of claim 18, wherein the user-interface events comprise at least one of pointer events, keyboard events, touch events, or accessibility-framework actions.

20. The non-transitory computer-readable medium of claim 18, wherein the operations are performed on-device.

21. A system comprising:
a user device including a display, one or more processors, and memory storing a local context store, wherein the one or more processors are configured to:
capture, at intervals, visual content presented on the display;
analyze the captured visual content by dividing the content into pixels and processing the pixels with a neural network trained to recognize visual elements and positions of the visual elements to produce an element map;
store, in the local context store, entries that associate the captured visual content with (i) a time, (ii) an application or window identifier, and (iii) descriptors of the recognized visual elements;
receive a natural-language user query describing a past activity;
retrieve, from the local context store, an entry responsive to the user query; and
re-establish at least part of a prior application state by programmatically generating user-interface events directed to a target visual element specified from the element map, without invoking application-specific deep links or intents.

22. The system of claim 21, wherein the user-interface events comprise at least one of pointer events, keyboard events, touch events, or accessibility-framework actions.

23. The system of claim 21, wherein the processors are configured to perform capturing, analyzing, storing, retrieving, and re-establishing on-device.

24. The system of claim 21, wherein the processors are further configured to extract tokens from the captured visual content using a text analyzer and store the tokens with the entry to facilitate retrieval by the natural-language user query.

25. The system of claim 21, wherein re-establishing comprises directing the user-interface events to elements exposed by an accessibility surface when available.

26. The method of claim 1, wherein the analyzing of the captured visual content comprises processing the pixels using a deep neural network (DNN) trained to extract hierarchical visual features representing layout, color, and interface-element patterns to improve recognition accuracy of the element map.

27. The method of claim 1, wherein the neural network comprises a recurrent neural network configured to model sequential dependencies and complex interactions between consecutive frames of the captured visual content, the recurrent neural network being trained on an input stream that includes sequential interactions and image vectors corresponding to pixels of the captured visual content and associated time data, and wherein the recurrent neural network is configured to predict transitions between user-interface states across time by generating a sequence of actions or recommendations based on the learned temporal relationships between the captured frames.

28. The method of claim 27, wherein the recurrent neural network comprises one or more Long Short-Term Memory (LSTM) cells arranged in an encoder-decoder structure trained by gradient-descent backpropagation to predict a next token or action in a sequence, wherein the LSTM cells are configured to receive time-series input vectors including image features, recognized text tokens, timestamps, and contextual data derived from user interactions, and wherein an attention mechanism operates on an encoded vector of the input sequence to preserve temporal context and improve prediction accuracy of subsequent actions or retrieval events.

29. The method of claim 1, wherein the neural network comprises a sequence-to-sequence model having an encoder-decoder architecture that includes Long Short-Term Memory (LSTM) cells and an attention mechanism, wherein the encoder is configured to process time-series input vectors representing aggregated user descriptors, including recognized text tokens, word embeddings of prior search queries, and visual feature vectors corresponding to captured images, and wherein the decoder is configured to generate predicted output tokens representing search queries or content items, the predicted tokens being provided to a ranking module comprising a deep feed-forward neural network configured to rank the output tokens according to their probability of relevance or popularity for presentation as interface targets or actionable recommendations.

30. The method of claim 1, wherein retrieving the entry responsive to the natural-language query comprises ranking candidate entries using a reinforcement-learning model that maximizes a reward signal based on user selections or confirmations of retrieved results, thereby improving subsequent recall accuracy.
